(19) United States
(12) Patent Application Publication
(10) Pub. No.: US 2007/0168339 A1
(43) Pub. Date: Jul. 19, 2007

(54) Continuing education using a system for supervised remote training

(75) Inventors: Daniel P. Vezina, Park City, UT (US); Theodore H. Stanley, Salt Lake City, UT (US)

Correspondence Address: GORDON E NELSON;PATENT ATTORNEY, PC, 57 CENTRAL ST, PO BOX 782, ROWLEY, MA, 01969, US

(73) Assignee: University of Utah Research Foundation, Salt Lake City, UT (US)

(21) Appl. No.: 11/685,394

(22) Filed: Mar. 13, 2007

Related U.S. Application Data
(63) Continuation-in-part of application No. PCT/US05/32854, filed on Sep. 15, 2005.
(60) Provisional application No. 60/781,803, filed on Mar. 13, 2006.
(60) Provisional application No. 60/617,515, filed on Oct. 8, 2004.
(60) Provisional application No. 60/621,752, filed on Oct. 25, 2004.

(51) Int. Cl. G06F 17/30

(52) U.S. Cl. 707/3

(57) ABSTRACT

Techniques for providing expert instruction in interpreting outputs of a test instrument to a student who is at a location remote from the expert. The student makes outputs from the test instrument and an interpretation of the outputs available to an expert via a network and receives a commented and graded response in return. The outputs, the interpretation, and the response may be made available in real time or in non-real time. In the non-real-time embodiment, the student makes his interpretation by selecting from menus of possible observations, the expert does the same, and the two interpretations are automatically compared to produce the comments and grade for the response. One application of the invention is teaching echocardiography.

### CROSS-REFERENCE TO RELATED APPLICATIONS

The present patent application claims priority from U.S. provisional patent application 60/781,803, Daniel P. Vezina, Continuing medical education using remote training and supervision, filed Mar. 13, 2006, and is a continuation-in-part of PCT US2005/032854, University of Utah Research Foundation, System for supervised remote training, filed Sep. 15, 2005, which in turn claims priority from two U.S. provisional patent applications having the same title and inventor as PCT/US2005/032854, U.S. provisional patent application No. 60/617,515, filed Oct. 8, 2004, and U.S. provisional patent application 60,621,752, filed Oct. 25, 2004. All of the applications listed in this section are incorporated by reference into the present application in their entireties and for all purposes. The present patent application includes the complete Detailed Description and Drawing from PCT/US2005/032854; the new material begins with FIG. 10 and the section titled A curriculum that uses the system for remote learning to teach echocardiography.

### STATEMENT REGARDING FEDERALLY SPONSORED RESEARCH OR DEVELOPMENT

Not Applicable.

### REFERENCE TO A SEQUENCE LISTING

Not Applicable.

### BACKGROUND OF THE INVENTION

1. Field of the Invention

The invention relates generally to techniques for providing continuing education for practicing professionals and more specifically to continuing education where what is being taught is the operation of a complex device and the interpretation of outputs from the complex device.

2. Description of Related Art

Continuing education is always a problem for people in highly-skilled professions. On the one hand, the pace of technological change is such that what one learned in professional school quickly becomes obsolete. On the other hand, the practicing professional simply cannot shut his or her practice down and go back to school for six months or so. One of the solutions to this problem is distance learning, either in its older form of correspondence school or the newer forms offered by the World Wide Web. As long as what is being learned is conceptual, well-designed distance learning can be perfectly satisfactory. The current modes of distance learning are, however, far less satisfactory where what is being learned requires “hands on” experience.

An example of training that requires hands on experience is training in echocardiography. Echocardiography is a noninvasive ultrasound echoing technology which permits the echocardiographer to get live and direct images of the heart and the major vessels connected to it. Echocardiography has been used for medical applications for about 40 years. Currently, the technology is mainly used by cardiologists in what are termed “echo labs”. These clinical labs study the hearts of patients for diagnostic reasons. For example, if a patient has significant shortness of breath during exercise; the physician needs to know if this problem is caused by pulmonary disease or heart disease (congestive heart failure). To find this out, the physician can request an echocardiogram of the heart, and in about 20 minutes the echo physician (echocardiographer) can image the heart structures and evaluate its function. The diagnostic power of echocardiography is great, painless, fast, and scientifically well recognized.

The presence of cardiac ultrasound in the operating room (OR) can be traced back 25 years, when an M-mode display on a gastroscope was the prevalent technology. Since that time, significant advancements in ultrasound technology, such as the application of 2-D imaging and color, pulsed wave (PW), and continuous wave (CW) Doppler, have made perioperative echocardiography more precise and user friendly. Through these advancements, the benefits of using perioperative echocardiography in a variety of procedural and clinical settings have become even more apparent.

Although perioperative echocardiography has been available for years and the scientific value is well established, there are still only a handful of anesthesiologists and intensivists who are adequately trained and proficient in performing perioperative echocardiography. To reverse this trend, great efforts have been made to establish guidelines for training and more recently, certification in perioperative echocardiography. Unfortunately, the requirements for the certification process are restrictive and impractical; they typically require physicians to stop their existing practice and enroll in a traditional fellowship program. Because this traditional approach is not realistic for the vast majority of physicians, the use of the technology has not reached its full potential.

More specifically, the limited participation by anesthesiologists and intensivists in more structured and comprehensive training programs can be explained by several factors.
Traditional perioperative echocardiography fellowships offer only a few positions every year.
Traditional fellowships require physicians to stop their medical practice for an extended period of time (usually between 6 and 12 months), resulting in significant financial stress/loss to the “student” physician.
The currently available continuous medical education process is rigid and inflexible. Most programs are inadequate and incomplete and do not provide physicians with the necessary tools and knowledge to become a fully proficient and competent perioperative echocardiographer. There is no mandatory rotation in echocardiography during residency training.
Becoming proficient in a medical imaging technique requires learning a complex new set of skills for anesthesiologists and intensivists, skills that often have no correlation to other existing skills used in their current practice.

The limited participation by anesthesiologists and intensivists in training programs for echocardiography has affected the quality of perioperative care. Since 1970, there has been a 50 percent reduction in liability claims related to respiratory events mainly due to the use of ETCO2 and pulse oximetry monitoring, as well as increased efforts promoted by the American Society of Anesthesiologists (ASA) to improve airway management strategies. On the other hand, during the same period of time, there was no change in the number of claims related to cardiovascular events.

The absence of a decline in cardiovascular-related claims despite an overall improvement in the quality of anesthesia care is a concerning situation. The basic standard of care for cardiovascular monitoring during anesthesia is the use of continuous ECG and non-invasive blood pressure measurements performed at regular intervals. When needed, continuous blood pressure monitoring with an arterial line or a pulmonary artery catheter can be performed, but these technologies have not significantly changed or improved within the last 25 years.

During the same time period, perioperative echocardiography was also introduced and proven to reduce perioperative complications and improve patient outcomes. However, as noted above, due to the limited number of adequately trained physicians, the full potential of the technology to reduce cardiovascular events and improve patient outcomes has not been realized. As a result, increased use of perioperative echocardiography by adequately trained physicians is desperately needed.

It is an object of the present patent application to overcome the difficulties which have prevented the widespread use of perioperative echocardiography and thereby to improve the quality of perioperative medical care.

### BRIEF SUMMARY OF THE INVENTION

The invention attains the object of overcoming the foregoing difficulties by providing a method of teaching a student who will be using a test instrument to interpret outputs of the test instrument. The method repeats a cycle of resident and non-resident instruction one or more times. The resident instruction is provided for a period of time which is short enough so that it does not substantially interfere with the student's non-resident activities. During the resident instruction, the student and an expert in interpreting the outputs from the test instrument are physically present. The non-resident instruction is provided to the student at the student's non-resident location. It includes receiving an interpretation of an output from the student, analyzing the interpretation, and providing the results of the analysis to the student.

In other aspects, the method includes instruction from the expert in the first cycle's resident instruction in how to use the test instrument and the analysis is done by comparing the student's interpretation of the output with an interpretation of the output made by the expert. The output interpreted by the student may either be output provided by the expert or output made by the student at the student's non-resident location. Where the output is output provided by the expert, the output is converted to a form which permits the output to be played on a browser.

In further aspects, the steps of analyzing the student's interpretation and providing results of the analysis to the student are automated by using menus to write the report. There is a menu for each aspect of the output which is to be interpreted and the menu indicates the possible ways of interpreting the aspect. A report is written by selecting the menu item that best describes the aspect of the output. In the step of analyzing, the analysis is done by comparing the menu choices made by the expert for the output and the menu choices made by the student. A final report for the student includes descriptions of the choices made by the expert which differ from those made by the student. Weights are further associated with differences between the choices made for an aspect of the output and the weights are used to determine a grade for the student.

A particularly useful application of the method is in teaching echocardiography. The reports interpret studies made using an echocardiograph machine and provide a way for the student to complete large numbers of supervised reports from his or her non-resident location. The method may, however, be employed with any kind of test instrument.

### BRIEF DESCRIPTION OF THE SEVERAL VIEWS OF THE DRAWINGS

FIG. 1: General overview of a system for remote training;

FIG. 2: Block diagram of a presently-preferred embodiment of the system for remote training;

FIG. 3: Overview of a GUI page in a preferred embodiment;

FIG. 4: Example study description page;

FIG. 5: Menu system and report terminology table definitions;

FIG. 6: Report data table definition;

FIG. 7: Example generated report;

FIG. 8: Example of a report with a reviewer menu;

FIG. 9: Details of real-time communication between the echo machine and the study display;

FIG. 10: Overview of a teaching method that uses the remote training system;

FIG. 11: Overview of a curriculum for teaching echocardiography using the remote training system;

FIG. 12: Details of one cycle of the curriculum of FIG. 11;

FIG. 13: Details of a case presentation in the curriculum of FIG. 11;

FIG. 14: Details of a workshop in the curriculum of FIG. 11;

FIGS. 15A and 15B: Details of a diagnostic exercise in the curriculum of FIG. 11.

FIG. 16 shows the login screen for the report writing GUI;

FIG. 17 shows the screen used to select a study for a diagnostic exercise for display;

FIG. 18 shows the screen used to select a student study to write a report on;

FIG. 19 shows the screen that is used to switch from writing a report on a student study to writing a report on a study for a diagnostic exercise;

FIG. 20 shows the screen that is used to select a study for a diagnostic exercise to write a report on;

FIG. 21 shows an example “ideal report” made by an instructor;

FIG. 22 shows a report made by a student about a study for a diagnostic exercise;

FIG. 23 shows a commented report made for a student study; and

FIG. 24 shows the screen on which the grade for a report is displayed.

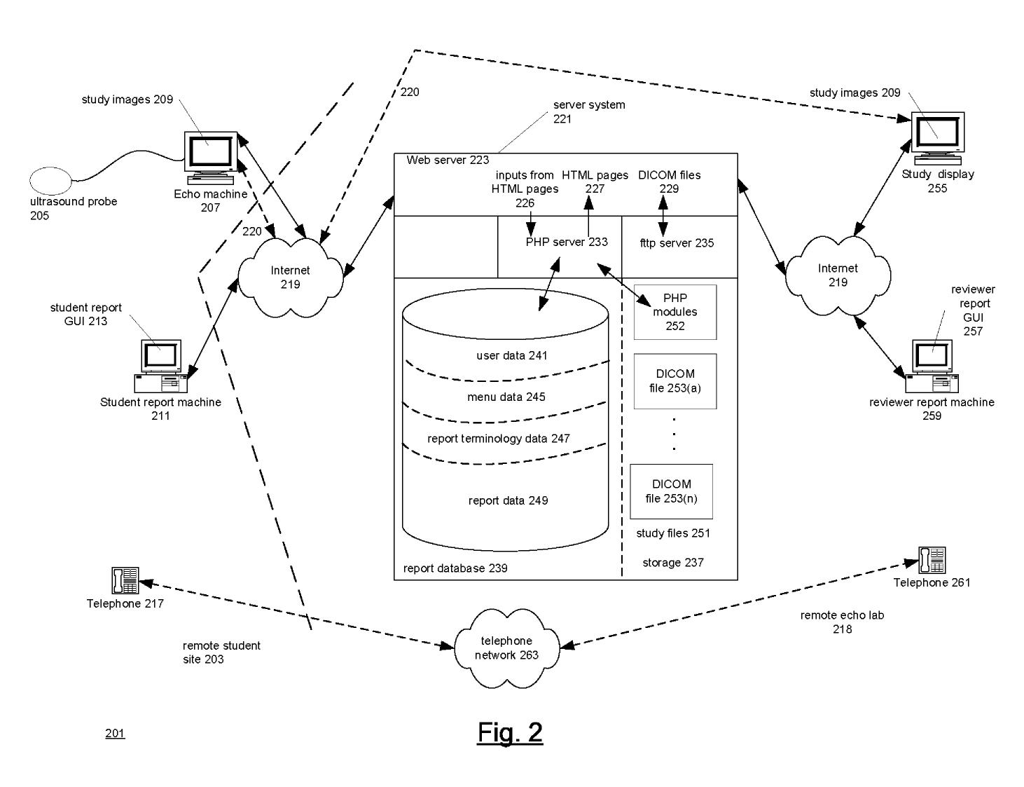

Reference numbers in the drawing have three or more digits: the two right-hand digits are reference numbers in the drawing indicated by the remaining digits. Thus, an item with the reference number 203 first appears as item 203 in FIG. 2.

### DETAILED DESCRIPTION OF THE INVENTION

The following Detailed description of the invention first describes the system for remote learning which is the subject of the parent of the present patent application. Then the Detailed description describes a curriculum which employs the system for remote learning to teach perioperative echocardiography to physicians without requiring that the physicians leave their practices. The techniques employed in the curriculum to teach echocardiography can of course be applied in any situation where intensive “hands on” training is required to use a device and interpret the device's outputs.

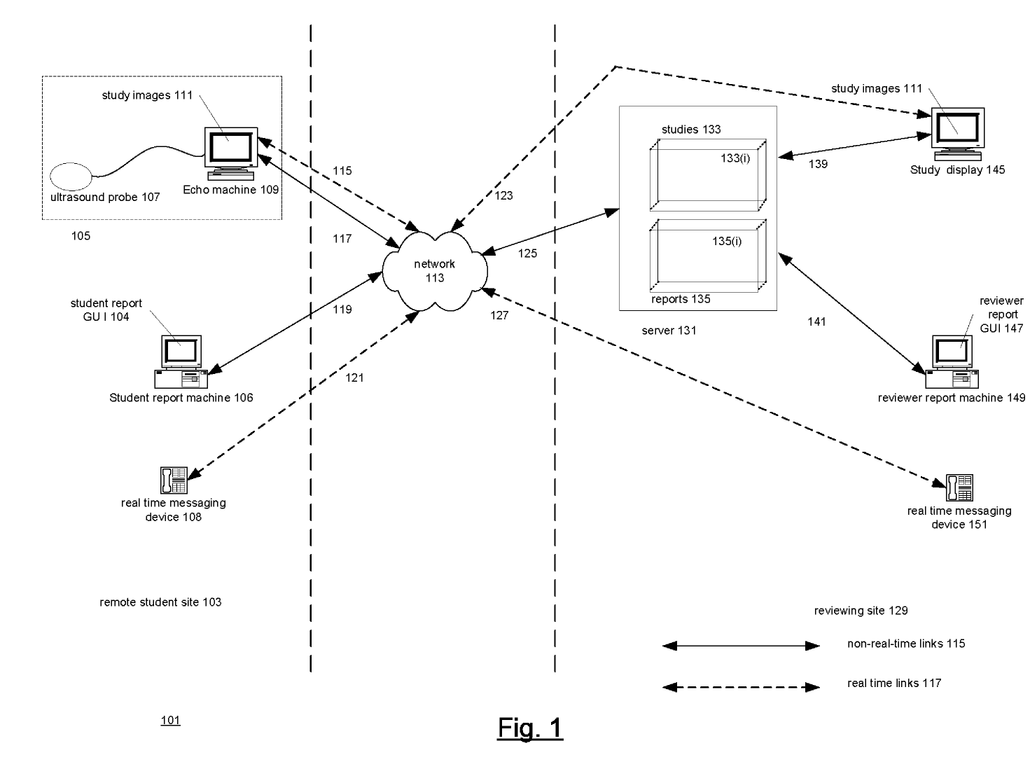

Conceptual Overview of the Remote Learning System: FIG. 1

FIG. 1 presents a conceptual overview of a system for remote learning 101. One part of the system is at a remote student site 103; another part of the system is at reviewing site 129; communication between remote student site 103 and teaching site 129 is by means of one or more networks 113. Two kinds of communication are possible via the networks in network 113: non-real-time communication in which there is no guarantee concerning the length of time it will take for a message will arrive and real time communication in which there are such guarantees. The Internet http file protocol is an example of non-real-time communication over a network and a telephone call or a teleconference are examples of real time communication over a network. Links between components of system 101 which provide real time communication are shown with dashed lines, as indicated at 117, while links which provide non-real-time communication are shown with solid lines, as shown at 115.

At remote student site 103 is a test instrument 105 which the student is being taught to use, a machine 106 which the student may use to make a report on output from test instrument 105, and a real time messaging device 108. All of these devices communicate via network 113 with teaching site 129. Test instrument 105 may be any kind of instrument which produces an output which may be stored for later analysis. The stored output from the test instrument is termed in the following a study. In a preferred embodiment, the test instrument is an echocardiograph machine 109 to which is attached an ultrasound probe 107. By inserting ultrasound probe 107 into the esophagus of a patient, images may be made of the beating heart of a patient. The images appear on display 111 of echo machine 109. Echocardiograph machine 109 may also make DICOM files of the images. The DICOM files may be played back at a later time in echocardiograph machine 109, and are thus the studies of the preferred embodiment.

In a preferred embodiment, student report machine 106 is a standard personal computer (PC) which includes a program that provides a student report GUI 104 for machine 106. The student uses the student report GUI to write a report about study images 111. Any other device which provided the student with a GUI to write the report could be used in place of machine 106. Examples would be personal digital assistants and “intelligent” cellular telephones. In other embodiments, echo machine 109 and report machine 106 may share a display or may be a single device that performs the functions of both echo machine 109 and student report machine 106. In the preferred embodiment, real time messaging is done using teleconferencing and a telephone call that is made as part of the teleconferencing; the teleconference permits a reviewer at reviewing site 129 and the student to view the output of echo machine 109 simultaneously, permits either the student or the reviewer to control echo machine 109, and permits the student and the reviewer to discuss what they are seeing on echo machine 109 and what to do next with echo machine 109. In other embodiments, the discussion could be done by means of instant messaging systems or Web telephony systems.

Reviewing site 129 has a server 131 which communicates with echo machine 109 and student report machine 106 via network 113. Server 131 executes the network protocols necessary for such communication and further stores studies 133 produced by echo machine 111 and reports 135 which have been produced by students at remote sites 103 and commented on by reviewers at reviewing site 129. Connected to server 131 are study display 145, a device which is able to display images made by echo machine 109 or images produced from a study 133(i), reviewer report machine 149, which is used by a reviewer to review a study stored at 133 or images received directly from echo machine 109, and real time message device 151, in this case a standard telephone. In other embodiments, there may be no server 131 and echo machine 109, study display 145, student report machine 106, and reviewer report machine 149 may communicate directly with each other via network 113. Again, single devices may perform the functions of echo machine 109 and student report machine 106 at remote site 103 and of teacher report machine 149 and study display 145 at reviewer site 129; further, the real time messaging function of device 108 may be incorporated into such a single device or into any of the devices at site 103 and site 129.

System 101 has two modes of operation: a reporting mode and a real-time mode. In the reporting mode, the student at remote student site 103 performs an examination using echo machine 109 on a patient and echo machine 109 creates a DICOM file of the examination. The DICOM file is study 133(i). The student then uses student report machine 106 to write a report 135(i) concerning study 133(i) and sends the study and the report to server 131 via non-real-time links 115 and 119. At reviewing site 129, the reviewer displays study 133(i) on study display 145, writes comments about report 135(i) on reviewer report machine 149, and returns the commented report to the student via non-real-time links 141, 125, and 119.

The real time mode is used when a student needs immediate help while he or she is using echo machine 109 on a patient. In this mode, the student sets up real time links 115, 123, 121, and 127. That done, the student and the reviewer can see what is displayed on echo machine 109 simultaneously, either can control echo machine 109, and both can simultaneously discuss what they are seeing and doing.

As may be seen from the foregoing, all that system 101 really requires to function is non-real-time network connections between the devices used by the student and the reviewer which permit the student to send a study and a report to the reviewer and the reviewer to return the commented study to the student and real-time connections between those devices which permit the reviewer to see the output of test device 105 as it is produced and to discuss what he or she is seeing with the student. In some applications, the ability to control instrument 105 in real time from reviewing site 129 is also useful.

Overview of a Preferred Embodiment of the Invention: FIG. 2

FIG. 2 shows a presently-preferred embodiment 201 of the remote learning system. The student is at remote student site 203; the reviewer at remote echo lab 218. The devices used by the student are echo machine 207 with ultrasound probe 205; the images produced by the echo machine are displayed at 209; the student uses student report machine with student GUI 213 to write reports and read commented reports and uses telephone 217 to discuss the images produced by echo machine 207 in real time. The devices used by the reviewer are study display 255, reviewer report machine 259 with reviewer report GUI 257, and telephone 261.

Also at remote echo lab 218 is server system 221, which includes storage 237. Storage 237 is to be understood to include persistent data storage. Echo machine 207 and student report machine 211 are connected to server system 221 by internet 219, as are study display 255 and reviewer report machine 259. The non-real-time ftp protocol is used to transfer study files 251 from echo machine 207 to server 221 and the non-real-time HTTP protocol, is used to transfer HTML pages from server system 221 to student report machine 211 and to receive responses to the HTML pages from the student. HTTP is similarly used to transfer HTML pages from server system 221 to reviewer report machine 259 and to transmit user responses to the HTML GUI back to the server. The real time links use a teleconferencing link 220 to provide the images produced by echo machine 207 via internet 219 to study display 255 as they are produced and to provide control information for echo machine 207 from study display 255. Telephone network 263 and telephones 217 and 261 further provide real time voice communication between student and reviewer. It should be noted here that because the Internet is used for communication between the devices used by the reviewer and server system 221 or echo machine 207, the reviewer may be at a location that is remote to server system 221.

Continuing with server system 221, the system contains one or more processors and memory including persistent memory. Included in server system 221 is code for a Web server 223 that can send and receive IP packets, code for a server 235 for the ftp, file transfer protocol, and code for PHP server 233. Server 235 is used to send and receive DICOM files. PHP server 233 is used to generate the HTML pages 227 sent via the HTTP protocol to GUIs 213 and 257 and to respond to the inputs 226 made to the HTML pages by the student or reviewer. In doing this, PHP server 233 executes PHP modules 252 and performs queries on report database 239. As shown by arrows 227 and 229, web server 223 receives IP protocol packets for servers 233 and 235 and provides the packets to the proper ones of those servers; similarly, servers 233 and 235 provide packets to Web server 223 to be placed on internet 219.

Contained in storage 237 accessible from server system 221 are DICOM study files 251 and report database 239, which contains all of the information needed to generate reports and comments on the reports. As will be explained in more detail later, writing reports and commenting on them is done by examining a study 253(i) and choosing an item from a menu in GUI 213 or GUI 257 that corresponds to what the study appears to show. The menu item specifies the descriptive terminology for what the study appears to show and the report is generated using the descriptive terminology specified by the menu picks.

As would be expected from the above, the information in report database 239 falls into four categories:
User data 241, which contains user information including user identification information, the user's password, and the user's type. In a preferred embodiment, there are three types of users: students, reviewers, and system administrators.
Menu data 245, which contains the data used to create a screen menu which lists the screens used in student report GUI 213 and reviewer report GUI 257.
Report terminology data 247, which contains text associated with menu items used in GUIs 213 and 257. The text includes prompts for the menu items and text that is included in a report when the menu item is selected.
Report data 249: this data relates a student to a study file, to the terminology in terminology data 247 for the report made by the student on the study file, and to the terminology for the comments made by the reviewer on the student's reports. PHP server 233 generates HTML pages for a report and a commented report from report data 249.

Operation in report mode is as follows: After the student has made a study using echo machine 207, he or she sends the DICOM file for the study to server 221, which stores it in study files 251. When the student wishes to do a report on the study, the student logs into the report making and generation system from student report machine 211. GUI 213 takes the student through a sequence of screens from which the student can select the DICOM file 253 he or she wishes to do a report on and then write the report by selecting descriptions of how the study was done and what it shows from report menus on the screens. When a student either submits his or her report menu selections or goes to the next page in the sequence, PHP server 233 responds to the report menu selections by placing indications of the terminology corresponding to the report menu selections in a record for the report in report data 249. When the student or reviewer wishes to see the report, he or she selects a final report screen to which PHP server 233 responds by generating the report from the record in report data 249 and the terminology in report terminology data 247. To comment the report, the reviewer uses reviewer report menus in GUI 257 in the manner just described. PHP server 233 generates a commented report that combines the student report with the comments added by the reviewer. In real time mode, the student sets up a teleconference between echo machine 207 and study display 255 which permits the reviewer to view the output of echo machine 207 in real time on study display 255 and to control echo machine 207 in real time. The student and reviewer use a telephone connection that is set up by the teleconference to discuss what the reviewer and student are doing and seeing.

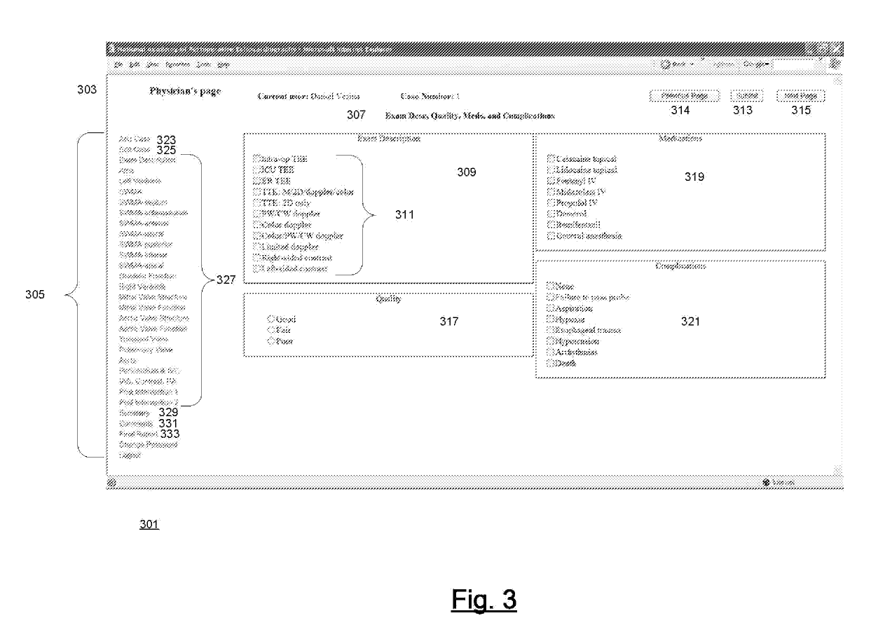

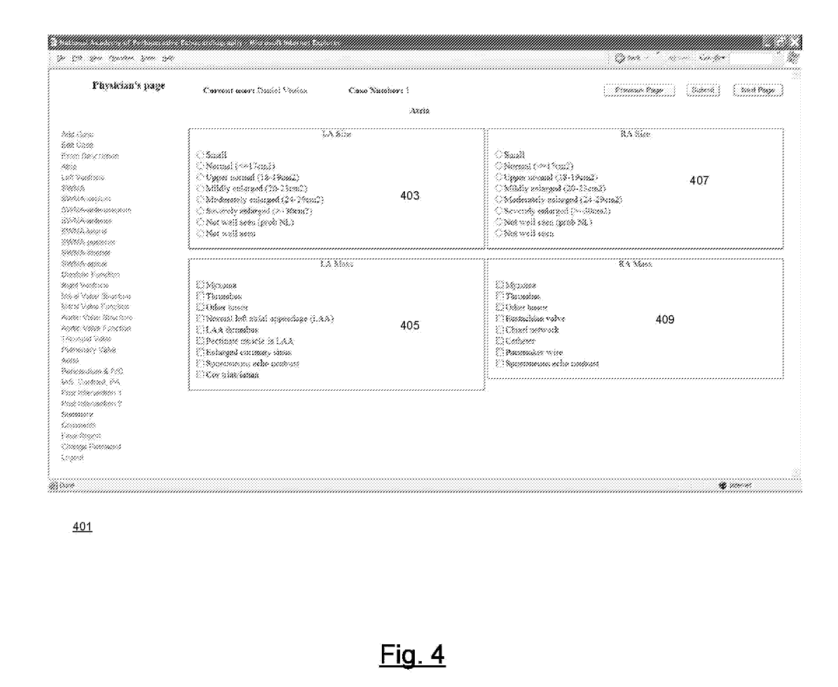

Graphical User Interface 213 in a Preferred Embodiment: FIGS. 3 and 4

FIG. 3 shows a typical screen 301 of GUI 213. Screen 301 is a screen which is used to collect information about the circumstances of the examination. The screen is produced in student report machine 211 from HTML provided by PHP server 233. Each screen has a record in menu data 245. Screen 301 is divided into three distinct sections: The top or header 303 where the user is identified and the submit 313, previous page, and next page 315 navigation buttons are displayed, the left hand side where screen menu 305 of links to other screens is displayed, and the middle section 307 where report menus are displayed.

Links in screen menu 305 which are particularly important in to the present discussion are the following:
Add Case 323, which takes the student to a screen which lets the student specify a DICOM file 253 and a patient which will be the subject of a report;
Edit Case link 325 which lets the student specify an existing report which is to be modified;
report writing links 327, which take the student to the screens which he or she uses to write the report;
Summary link 329, which takes the student to a summary of the report which is generated by PHP server 233 from the report data 249 for the report and report terminology data 247;
comments link 331, which takes the student to the reviewer's comments on the report; and
Final Report link 333, to which PHP server 233 responds by generating the report from report data 249 for the report and report terminology data 247.

In system 201, students and patients are related to DICOM files 253 as follows. Each student has a student ID, and when the student downloads a DICOM file 253 from echo machine 207 to server system 221, the student prepends the DICOM file's file name with the student's identifier. In the screen that is navigated to by Add case link 323, drop-down menus in the screen list the student's patients and the student's DICOM files. The student adds a new report for a selected patient and DICOM file combination to system 201 by selecting from these menus. The new report receives a machine-generated case number. The screen that is navigated to by Edit Case link 325 includes a drop-down list which shows the case numbers for each of the student's reports and the names of the report's patient and the DICOM file for the report's study.

The content specific to the screen includes screen menu 305 and a set of four report menus; at 309 is a report menu 311 that the student can use to indicate the kind of exam given; at 317 is a report menu the student can use to indicate his or her opinion of the exam's quality; at 319 is a report menu the student can use to indicate the medications that had been given the patient prior to the examination; and 321 is a report menu the student can use to indicate complications that occurred during the examination. To select an item in a report menu, the student clicks on the item's check box or radio button.

When the student is satisfied with his or her choices in the report menus and wishes them to become part of the report data 249 for the report, the student clicks on either submit button 313, previous page button 314, or next page button 315. Clicking on the former button causes PHP server 233 to write indications of the menu choices to the report data 249; clicking on the latter button does that and also causes PHP server 233 to provide machine 211 with the next screen in a programmed sequence of screens; clicking on the previous page button causes the PHP server 233 to write indication of the menu choices to the report data 249 and to go back to the previous page in the sequence of pages. If the student wishes to go to another screen without saving the menu choices in report data 249, the student clicks on the screen's link in screen menu 305 and PHP server 233 responds by going to the screen associated with the link.

Header

The software that produces the header area is programmed to consistently show which user mode is currently in effect, which user is logged in, and the case identifier of the case that is being worked on. The software is contained in a single php module in PHP server 233 that is included with other php modules for the report making and generation system. System 201's users and their permissions are stored in user data 241 in the database. When a user logs into the system and is authenticated a php session is created. The user's credentials, permissions, user ID, and name are associated with the session. As each HTML page for a screen is rendered the software goes to the session instance to procure the user's name and permissions to use for display and in the pertinent logic.

The software produces buttons 313, 314, and 315 which have the same appearance on each screen, but whose behavior is dynamically determined at run time. The settings for the buttons in the header are stored in hidden HTML fields. When a button is pressed, javascript responds to the event associated with pressing the button by changing change the value of the nextform field so that when the current screen is received by the software that processes the inputs to the current form, that software knows the URL of the previous or next page.

Screen Menu 305

The software that generates screen menu 305 is programmed to take the user's permissions and based off of the permissions retrieve the appropriate menu selections from menu data 245 and dynamically produce menu 305 at run time. In the database is stored the following: 1) the menu position or the numerical order of the prompt, 2) the URL associated with the menu selection, 3) the text which will be displayed on the menu, 4) the permission level associated with the menu item, and 5) whether the menu item is active/inactive. This allows changes to the system that produces screen menu 305 by altering records in menu data 245 rather than changing the software.

saveData.php

All screens are processed by savedata.php. Based on the setting of the nextform field savedata.php can determine the URL for the next screen to be created and sent to the user. saveData.php is called by all of the screens that are sent to the browser. Another hidden HTML field found in each screen is currentForm. The saveData.php module keys off of the currentForm field. Logically saveData.php looks for the value of currentForm which leads to the logic that is specific to the retrieval of data from the screen and proper storage of the retrieved data in report data 249.

Once the proper section of logic within the saveData.php module is found the value of the hidden HTML field isDirty is used to decide whether there is new data on the screen that needs to be processed and stored in report data 249. If isDirty is set to ‘true’ then the logic will retrieve data specifying the items corresponding to the selected menu items, format that data for storage, and save it in the appropriate fields in the records in report data 249.

The report menus are set up so that each report menu item is mapped to a dictionaryNumber and decimalNumber that is specific to the row in report terminology data 247 that contains the information corresponding to the selected menu item. saveData.php saves the dictionaryNumber and decimalNumber corresponding to each selected menu item in a field of the row for the report in report data 249. Each pair of dictionaryNumber and decimalNumber for a given field is concatenated with an underscore, then the pairs, if there is more than one, are concatenated into a comma delimited string, and is stored in the field. Once the data in the form is processed, saveData.php uses the value in nextForm to redirect the browser request to the URL for the next screen that should be produced by PHP server 233 and provided to machine 211.

Generation of Individual Screens

The HTML for the individual screens of GUIs 213 and 257 is generated by the PHP modules 252 that are executed by PHP server 233. Each PHP module 252 has “include” statements that bring in standardized or re-usable code used across all PHP modules 252 that checks to make sure the user has a validated PHP session running. If a session cannot be found then the user will be sent to the login screen. Re-usable code is also included that opens and maintains a database connection during the server side processing of the page. Each page further uses include statements to bring in the aforementioned header, menu, and javascript code, all of which is processed by PHP server 233 to generate and render an HTML page 227 that is sent down to the user's browser on machines 211 and 259.

The content portion of each HTML page 227 makes it unique. The main parts of the content portion are screen menu 305 and the various user interfaces, such as the report menus, that solicit input from the user. The HTML content further includes the hidden HTML fields that hold the settings for the current, previous and next page navigation buttons and the items in the report menus. There is logic in each PHP module which queries report terminology data 247 to obtain the information to generate the HTML page for the user interfaces. The items for each report menu are stored in records that belong to a specific range of values specified by the dictionaryNumber and decimalNumber fields that make up the keys of the records in report terminology data 247; the data returned by the query from report terminology data 247 for each menu item includes the values of the dictionaryNumber and decimalNumber fields and a character string that labels the menu item. The logic found in the PHP modules then acts against the values retrieved from report terminology data table 247 to produce the HTML code to form the requisite radio button, check box, or other GUI structures that comprise the user interfaces that collect data from the user. Internal to this logic is other logic that checks whether the user has already selected and stored data relevant to the current study and the user interface being. If any already selected user interface item is found, then appropriate radio buttons, selection set item, text box, text area, and check boxes are set in the user interface to indicate that the item has been selected and text areas associated with the menu item are populated as required by the selection.

Each page further contains a hidden HTML form variable, isDirty. The purpose of this variable is to keep track of whether input from the user has changed the value of any field within the screen. By default is Dirty is set to ‘false’. However, if any field is changed the browser-based event resulting from the change will trigger a javascript routine that will change the setting of isDirty to ‘true’. Once set, even if the changes are reversed the variable will remain set to ‘true’. There is only one instance of isDirty for the entire page, regardless of how many menu items there are in the page.

Actions Involving Link List 305 and Buttons 313, 314, and 315

Although screen menu 305 and buttons 313 and 315 will allow the user to navigate to the same screens within the system and both will find and present any existing screen, there is one difference between the two. Clicking on either submit button 313, previous page button 314, or next page button 315 results in the current screen being processed by saveData.php. Consequently, fields in the record in report data 249 corresponding to the user and the study are set as specified by the report menu selections made by the user. Clicking a link on the menu system, by contrast, results in PHP Server 233 going directly to the screen specified by the link, regardless of the setting of is Dirty. Thus, when the user goes directly to the requested screen, any data new entered into the current screen will be lost. Previously-submitted data will not be lost.

Another Example of a Menu Screen: FIG. 4

FIG. 4 shows an example of the screens which the student uses to indicate what he or she sees in the study. As indicated by the title for the screen, the screen permits the student to indicate what the student sees in the left and right atria of the heart. The only difference between screen 301 and screen 401 is that each of report menus 403-409 is for a different aspect of the examination of the left and right atria and contains menu choices for that aspect of the examination. Thus, menu 403 permits the student to indicate the size of the left atrium. Since the atrium can have only one size, the menu is a menu of radio buttons, i.e., only one choice is permitted. Report menu 405, by contrast permits the student to indicate any masses that he or she sees in the left atrium. Since more than one kind of mass may be present, report menu 405 has check boxes instead of radio buttons.

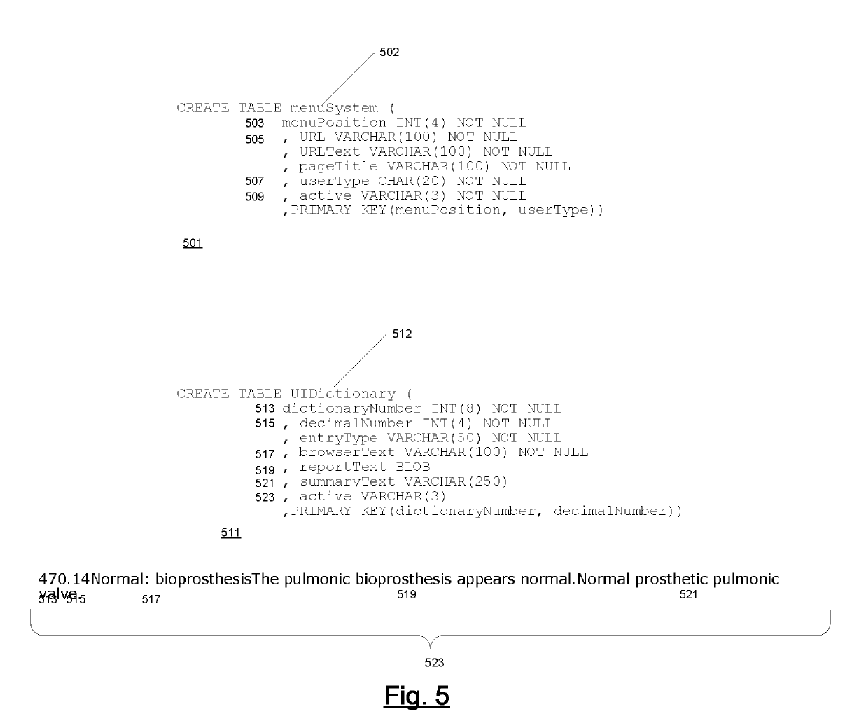

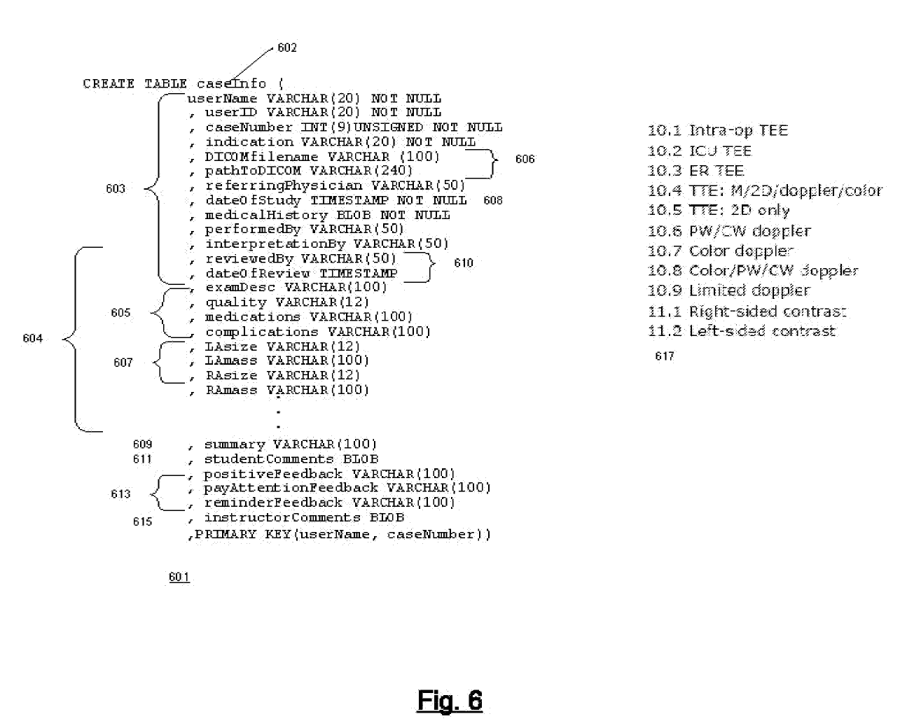

Details of Report Database 239: FIGS. 5 and 6

In a preferred embodiment, menu data 245 is a table called menuSystem which contains a row for each item in screen menu 305 that is used in student report GUI 213, reviewer report GUI 257, and a further GUI (not shown) for the system administrators. Report terminology data 247 is a table called UIDictionary which contains a row for the terminology description corresponding to each report menu item in GUI 211 or GUI 257. FIG. 5 shows the CREATE TABLE statements used to create these tables in SQL.

At 501 is shown the CREATE TABLE statement for menuSystem table 502. The statement lists the table's columns. There is a row in menuSystem table 502 for each item in any of the screen menus 305. Columns of interest in the present context include menuPosition 503, whose value in a row indicates the position of the item corresponding to the row in screen menu 305, URL column 505, whose value in the row indicates the URL of the screen specified by the menu item, userType 507, which indicates the type of user the menu item is intended for, and active 509, which indicates whether the menu item specified by the row is currently being used in system 201.

At 511 is shown the CREATE TABLE statement for UIDictitonary table 512. Columns of interest in the present context include dictionaryNumber column 503, whose value in row indicates the dictionary number of the dictionary number-decimal number pair that identifies the terminology description; decimalNumber column 515's values indicate the decimal number of the pair; browserText column 517 contains the text which is to be used in the report menu items which specify the terminology description; reportText column 519 contains the text which appears in the report when a report menu item that specifies the terminology description is selected. summaryText 521 contains a summary of the text which appears in the report which is used to generate a short summary of the report. active column 523, finally, indicates whether the terminology description is currently being used in system 201. An example row from table 512 with reference numbers corresponding to the reference numbers for the columns of the table is shown at 523.

FIG. 6 shows the CREATE TABLE statement for caseInfo table 602, which implements report data 249 in a preferred embodiment. There is a row in caseInfo table 513 for each report that has been made by a given student on a given DICOM file belonging to a given patient as well as a row for each commented report which a reviewer bases on a particular report. As will be explained in more detail in the following, the row for the commented report differs from the row for the report on which it is based in that the row specifies the information added by the reviewer in the comment and has a timestamp which is later than the time stamp on the report.

There are columns in caseInfo table 602 for information related to the study as a whole, for every report menu that appears in either student report GUI 213 or reviewer report GUI 257, for the report summary, for student comments, and for reviewer comments. The contents of fields belonging to the columns are for the most part obvious from their names. The fields containing information related to the study as a whole are shown at 603. Fields of section 603 that are of particular interest in the present context are the fields at 606 which relate the report to the DICOM file 253 for a study, field 608, which is a timestamp that is set when the student sets up a new report, and fields 610, which indicate the reviewer and a timestamp that is set to the current time first time the reviewer edits the commented report. A portion of the columns for the report menus is shown at 604; the columns at 605 are those for the report menus of screen 301; the columns at 607 are those for the report menus of screen 401. Column 609 is for the summary, column 611 is for written student comments, the columns at 613 are for the report menus that appear in reviewer report GUI 257, and column 615 is for written reviewer comments. Fields in the columns at 613 and 615 can be written only by the reviewer.

In the columns for the report menus and for the summary, the information indicated by the menu items selected by the student or the reviewer is indicated by the dictionaryNumber-decimalNumber pair that identifies the record in UIDictionary table 512 that contains the information specified by the menu selection. For example, the dictionaryNumber-decimalNumber pairs for menu 309 are shown at 617; if the student selects both TTE:M/2d/doppler/color and TTE:2D only from menu 311, the examDesc field in section 605 will contain the comma delimited character string “10_{—}4, 10_{—}5”.

Report Generation

A report goes through two stages:
first, it is a final student report;
when the reviewer has added comments, it becomes a final commented report.

Both stages are generated by PHP server 233 in the same fashion; the difference between them is that at the final student report stage, the row for the report in caseInfo has no data in the fields corresponding to columns 613 and 615. At the final commented report stage, the reviewer has added comments, and there is consequently data in the fields corresponding to those columns.

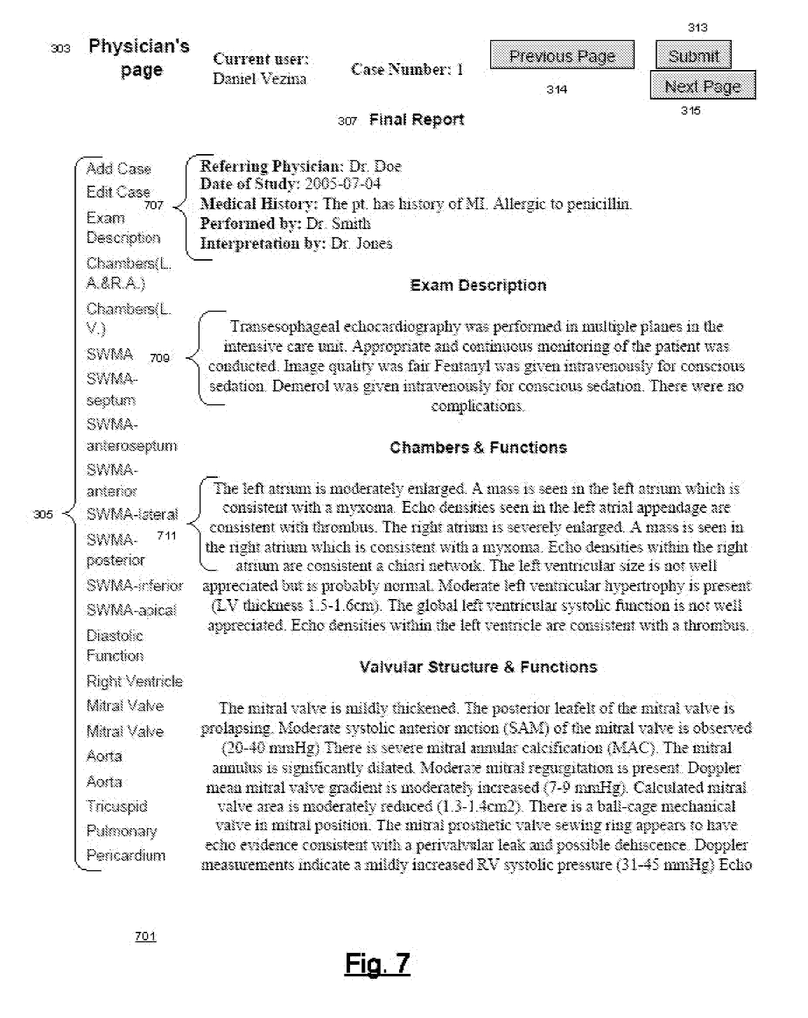

Generating a Student Report: FIG. 7

A student can work on any of his or her studies by selecting Edit CASE 325 in screen menu 305 and using the drop-down menus in the Edit Case screen to select the report that he or she wishes to work on and then using the screen menus 305 to navigate to the screen for the part of the study he or she wishes to work on. When the student believes that a report is done, the student selects Final Report menu item 335 in screen menu 305. In response to this selection, PHP server 233 generates an HTML page containing the report from the report's row in caseInfo table 602 and displays the generated page in GUI 213.

FIG. 7 shows a part 701 of a report page. The screen on which report page 701 appears has all of the parts of the screens used generally in GUIs 213 and 257, except that the text of the report appears where otherwise the report menus would appear. The information in the report's text comes directly from the report's row in caseInfo, as may be seen by comparing the contents of the report at 707 with the fields at 603 in the caseInfo record, the contents at 709 with the fields at 605 in the caseInfo record, and the contents at 722 with the fields at 607 in the caseInfo record. To make the parts of the report that are selected from report menus by the student, PHP server 233 queries UIDictionary table 512 using the dictionaryNumber-decimalNumber pairs stored in the caseInfo row corresponding to the report menu selection to locate the rows that correspond to the selected menu items and then outputs the contents of reportText field 519 for those rows to the report.

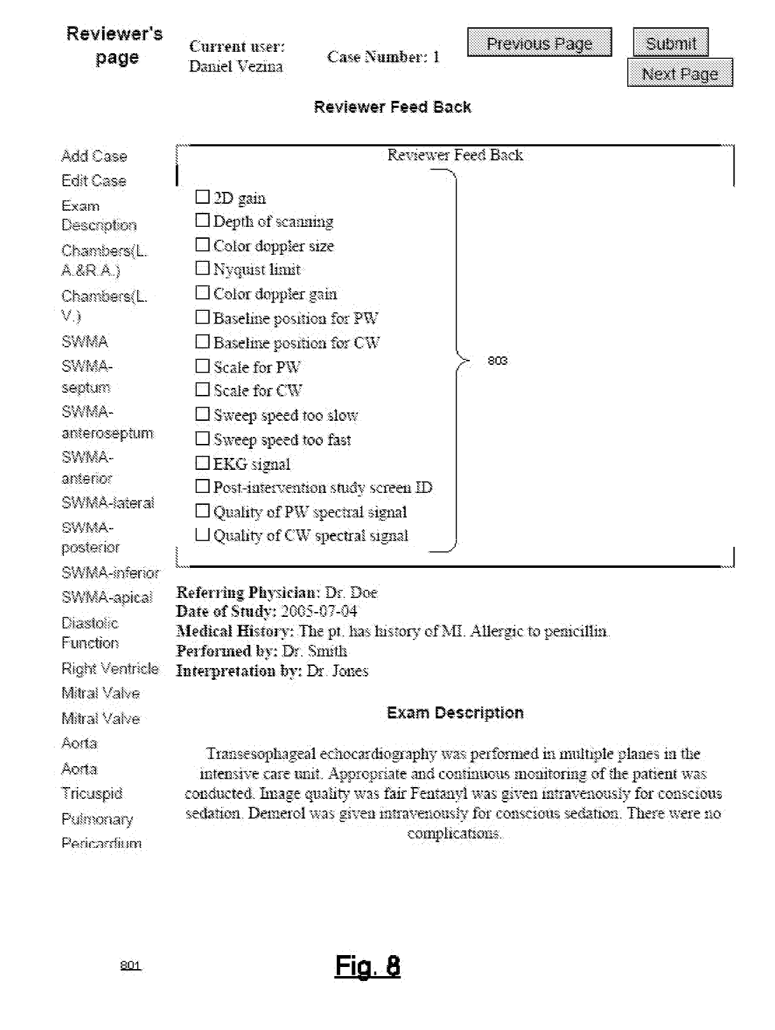

Making a Commented Report: FIG. 8

When the reviewer wishes to make a commented version of a final report submitted by a student, he or she uses the Edit Case menu selection 325, which takes the reviewer to a page which has a drop-down list of the student reports which have been submitted to him/her but not yet commented. When the reviewer selects a student report for commenting from the list, PHP server 233 makes a new row in caseInfo table 602 for the commented report. The new row is a copy of the row for the student report. At the same time the existing record, created by the student, is locked to prevent further changes. The reviewer, but not the student, has access to the new row for editing. All information in both rows will be available to the student and the reviewer via the final commented report.

The reviewer makes the commented report by selecting items from the report menus which provide the data which is stored at 613 in FIG. 6. There are three such reviewer report menus, one which has entries for positive feedback of all kinds, one which has entries for items relating to the way the student is operating echo machine 207, and one which has entries concerning problems with the student's analysis of the study. The text that is to be used for the menu items and is to be included in the report is of course in rows in UIDictionary table 512. When the reviewer clicks on the Submit, Previous Page, or Next Page button, the reviewer report menu selections are written to the corresponding fields 613 in the caseInfo record for the commented report.

FIG. 8 shows reviewer report menu 803 for items relating to the way the student is operating echo machine 207. Menu 803 is superimposed upon the report 801 being commented. In other embodiments, the display may be split into two screens, one of which shows the report and the other of which shows one of the reviewer report menus. In still another embodiment, the reviewer may work with a paper copy of the report and the display may show only the reviewer report menu.

The reviewer can edit the commented report in the same fashion that the student edited the original report; when the reviewer is satisfied with the commented report, the reviewer may notify the student that the commented report is ready. Either the student or the reviewer may use the Final Report menu selection to generate a Web page producing the commented report.

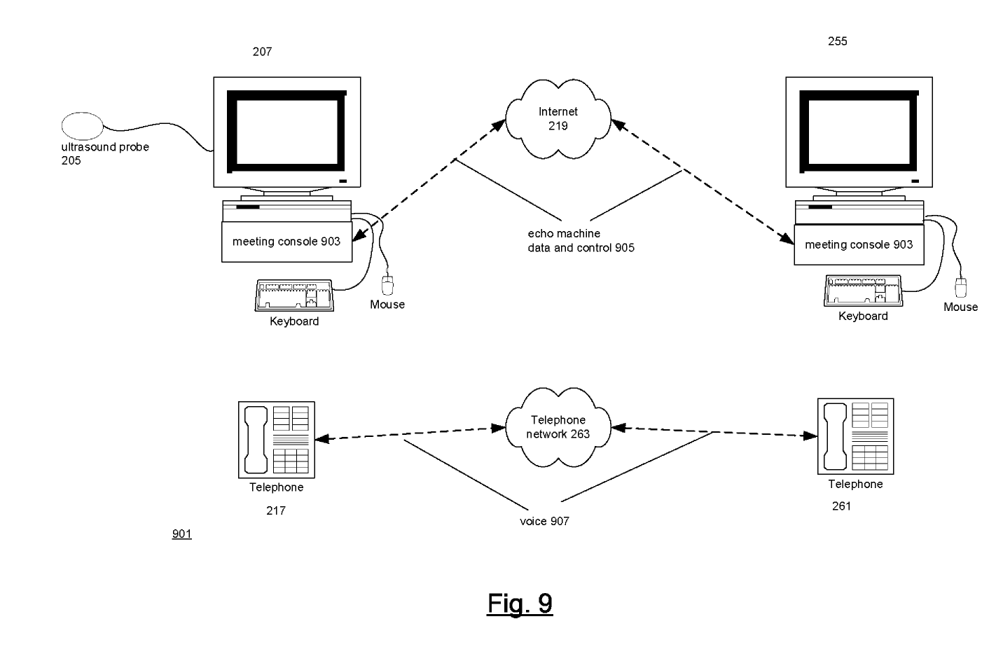

Real Time Analysis of Echo Machine Images: FIG. 9

A feature of system 201 is that it provides the student with the opportunity of consulting with the reviewer in real time during the actual echocardiograhic examination. This feature is particularly important in system 201 because the examinations being performed are being done on actual patients. Consequently, the student must be able to quickly consult a reviewer if he or she encounters something in the examination which he or she does not immediately understand. In system 201, real time consulting is provided by having at least one reviewer present in the remote echo lab at all times and by making it possible for the student to set up a teleconference with the reviewer at any time. In the teleconference, the reviewer may not only see the images being produced by echo machine 207 as they are produced on study display 255, but may also use the mouse and keyboard of study display 255 to control echo machine 207 in exactly the same way as if the reviewer were controlling an echo machine at the reviewer's location.

FIG. 9 shows a presently-preferred implementation of the real-time mode in system 201. As shown at 901, echo machine 207 at student site 203 is connected via the Internet to study display machine 255. Both machines have meeting console software 903, which handles inputs to and outputs from echo machine 207 and study display machine 255. The inputs are received from and the outputs are output to Internet 219. Discussions between the student and the reviewer take place via telephones 217 and 251 and voice network 263.

Set up of the teleconference is handled by a teleconference hosting service which runs on a Web server in Internet 219. The hosting service may be run by a hosting company or it may be provided by the entity doing the training. In the latter case, the hosting service might run in server system 221. The exact way in which the set up is done will depend on the hosting service. In a hosting service which is presently available under the service mark “conferenceplace”, set up is done by the student using a plugin provided by conferenceplace in his email program to send an email to the remote echo lab requesting a teleconference. The plugin sends the email to conferenceplace, which sets up real time link 220 between echo machine 207 and study display 255 and the phone link between student site 203 and echo lab 218 and then sends email inviting the student and the reviewer to participate. When responses have been received from both, conferenceplace activates real time link 220 and the phone link. During the teleconference, the output of echo machine 207 is simultaneously visible on both echo machine 207 and study display 255 and echo machine 207 may be controlled by mouse and keyboard inputs from either machine. For example, if the reviewer uses the mouse and cursor to point out a feature on the DICOM image, both the reviewer and the student will see the same image and the cursor in the same position on both machines.

A Curriculum that Uses the System for Remote Learning to Teach Echocardiography

The following discussion will first present an overview of a general curriculum for using system for remote learning 101 to teach students who will be using a test instrument and interpreting the instrument's results in their employment without disrupting the employment and will then present a curriculum for teaching echocardiography as a specific example of the general technique.

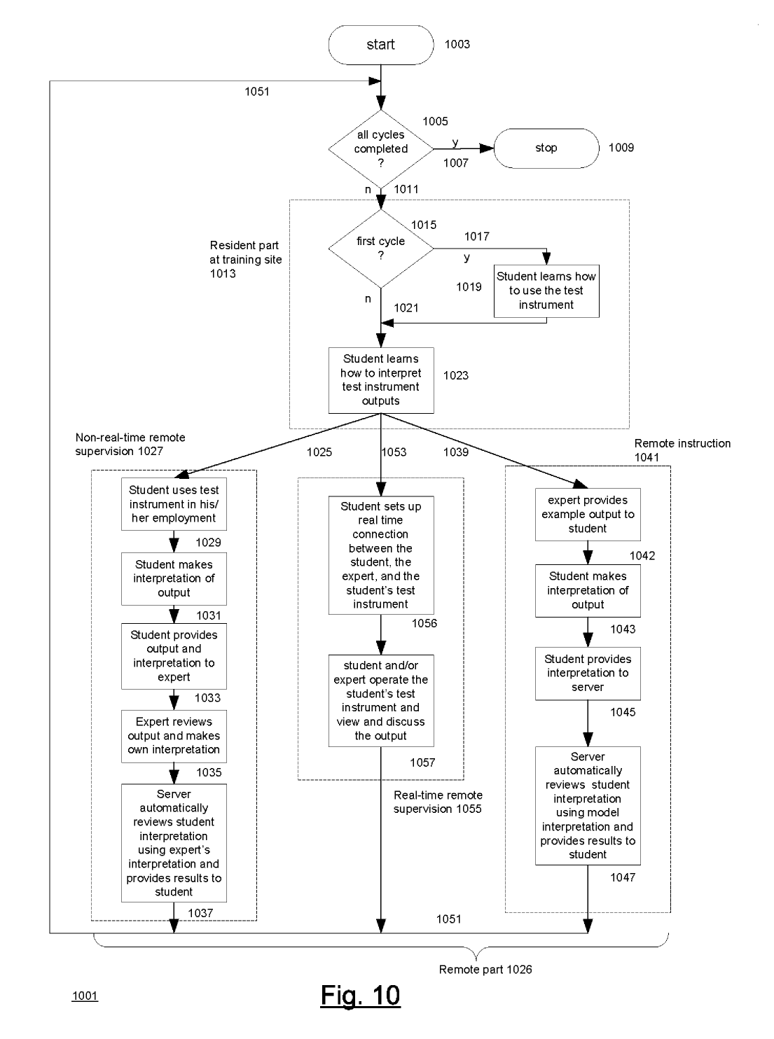

Teaching Students how to Use a Test Instrument and Interpret its Output without Disrupting their Employment: FIG. 10

FIG. 10 is a flowchart 1001 of a curriculum which uses system for remote learning 101 to teach students how to use a test instrument and interpret its output without disrupting their employment. Beginning at start terminator 1003, as indicated by loop 1051 and decision box 1005, the curriculum consists of one or more cycles. Each cycle has two parts:
A resident part 1013 for which the student must be personally present to receive personal instruction at a training site. The instruction is by experts in the use of the test instrument and the interpretation of its output.
A remote part 1026 during which the student works at his or her employment and receives remote supervision 1027 or 1055 and/or remote instruction 1041 from the experts.

The duration of the resident part in each cycle is short enough that the need for the student to be at the training site does not disrupt the students employment. When the student has completed all of the required cycles, he or she is able to independently use the test instrument and interpret its output in his or her employment, as indicated by stop terminator 1009.

Continuing with resident part 1013, if the cycle is the first cycle of the training, the student is taught how to use the test instrument (1015, 1017, 1019). Otherwise, the student receives further training in interpreting the output of the test instrument (1021, 1023). Instruction in resident part 1013 takes forms in which personal interaction between the experts and the students is particularly beneficial. Examples are lectures, case presentations with interactions between the students and the experts, in class interpretation of the output, and hands-on training in using the test instrument.

In remote part 1026, the student is being remotely supervised by an expert in non-real time (1027) receiving remote instruction (1041), and if the student needs help using the test instrument in his employment, being remotely supervised by an expert in real time (1055). Remote supervision in non-real time and in real time is done as explained in the parent of the present patent application: Beginning at branch 1025, in remote supervision, the student uses the test instrument in his or her employment (1029), makes an interpretation of the output (1031), and provides both the output and the interpretation to the remotely-located expert (1033). The expert reviews the output and makes his own interpretation (1035). Server 221 makes an analysis of the student's interpretation by comparing it with the instructor's interpretation and provides a commented interpretation to the student (1037). If the student requires expert assistance while using the test instrument (branch 1053), the student can establish a real time connection with the expert which permits the expert to assist the student and even control the test instrument in real time (1056). The student and the expert then collaborate in using the test instrument (1057).

In remote instruction 1041, the student receives example output from the expert (1042) via the telecommunications medium, interprets the output (1043), and provides the interpretation to a server (1045). The server then performs an automatic review of the interpretation using a model interpretation provided by the expert and makes the results of the review available to the student (1047). Remote instruction is thus like remote supervision, except that the students report is done on example output provided by the expert. In other embodiments, the instructor may simply mark up the students report in either remote supervision 1027 or remote instruction 1041. The remote part continues until it is time to begin the next cycle. At that point, the student returns to the training center and does the next resident part, as shown by loop 1051.

An Example Echocardiography Curriculum

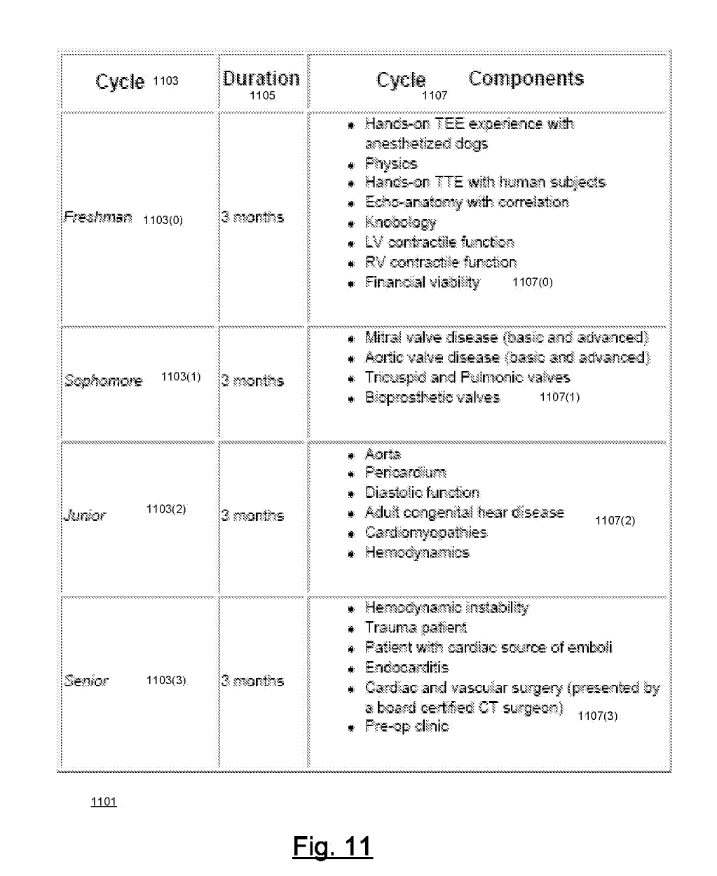

Overview of the Curriculum: FIG. 11

FIG. 11 is a table 1101 which contains an overview of a preferred embodiment of the example echocardiography curriculum. The curriculum contains four cycles 1103(0 . . . 3). Each cycle is three months long (1105). The resident part occupies three days of each cycle. The materials to be learned in each cycle are shown at 1107(0 . . . 3). Use of the echocardiogram is taught on dogs and human subjects in the first cycle (1107(0)).

Overview of the Residential Part

Three different teaching techniques are employed during the residential part of each cycle:

1) Lecture Series
a. The lectures are one or two-hour didactic sessions where a specific topic will be presented by one of the instructors. These lectures are internet-based and can be accessed at anytime during the resident and remote parts of the training. The lectures are structured to present a clinical approach to the different concepts in perioperative echocardiography. They are not intended to replace basic knowledge chapters from the textbooks. Students are encouraged to read the basic textbook chapters on their own time.

2) Case Presentations
a. The case presentations are one-hour periods where the faculty will present a short clinical scenario involving real patients, followed by a few echocardiography images relevant to the case. One or two questions will be asked and the student will be expected to interact and answer the questions. Positive discussions and feedback will be conducted by the faculty. The cases are usually short and cover a specific topic recently presented during a lecture series. The images presented will specifically help resolve the clinical challenge presented by the case.

3) Diagnostic Exercises
a. The diagnostic exercises are one to two-hour periods where the complete integration of the knowledge acquired is put in action. This is the ultimate experience for the training in echocardiography. Under the direction of a faculty, a short clinical scenario will be presented. Then, a complete echocardiography examination (either TEE or TTE) will be shown over a 3-4 minute period. No comments will be made at this point. Then, the student generates a report of his/her findings. After a few minutes the case will be reviewed with the faculty and an auto-correction of the student's diagnostic findings will be done. These diagnostic exercises are challenging but extremely valuable as a teaching tool.

Additionally, the first cycle includes two workshops in using the echocardiograph.

4) Workshops
a. The first workshop is dedicated to learning how to perform a complete transesophageal (TEE) echocardiography; the second is dedicated to acquiring the basic skills to perform a limited transthoracic (TTE) examination.
b. The two-hour TEE workshop is conducted using an anesthetized dog. After reviewing the concepts and sequence of imaging with the faculty, the student performs 2 to 4 complete examinations under direct supervision. Looking at other student's examinations and listening to the instructor's comments are also very valuable means of learning and improving technical skills.
c. The two-hour TTE workshop uses human male models. After reviewing the concepts and sequences of imaging with the faculty and the sonographer instructor, the student performs 2 to 4 limited TTE examinations on the models under direct supervision. Looking at other student's examinations and listening to the instructors comments are also very valuable means of learning and improving technical skills.
   Overview of the Remote Part

The remote part of the echocardiography curriculum is performed as shown in FIG. 2, which is part of the parent of the present application. All of the DICOM documents which are used in the curriculum, including DICOM documents generated by students as part of remote supervision and DICOM documents used in remote instruction, are stored in study files 251. In the preferred embodiment, students use a Web browser to view studies in remote instruction and to write reports in remote instruction and remote supervision and the instructors use the browser to comment on the studies in remote supervision. The GUIs for viewing studies in remote instruction and writing and commenting on reports are thus all implemented in server 221 and provided via the Internet to browsers on PCs or workstations belonging to the student or the instructor. In remote instruction, students use two Web browser windows, a study viewing window in which the student may play the study that is being used for remote instruction and a report window in which the student may write a report about the study currently being played in the study viewing window. In remote supervision, the student and the instructor use the report window to write the report and comment on it. The GUI for the report window has the general form shown in FIGS. 3,4,7, and 8 of the parent.

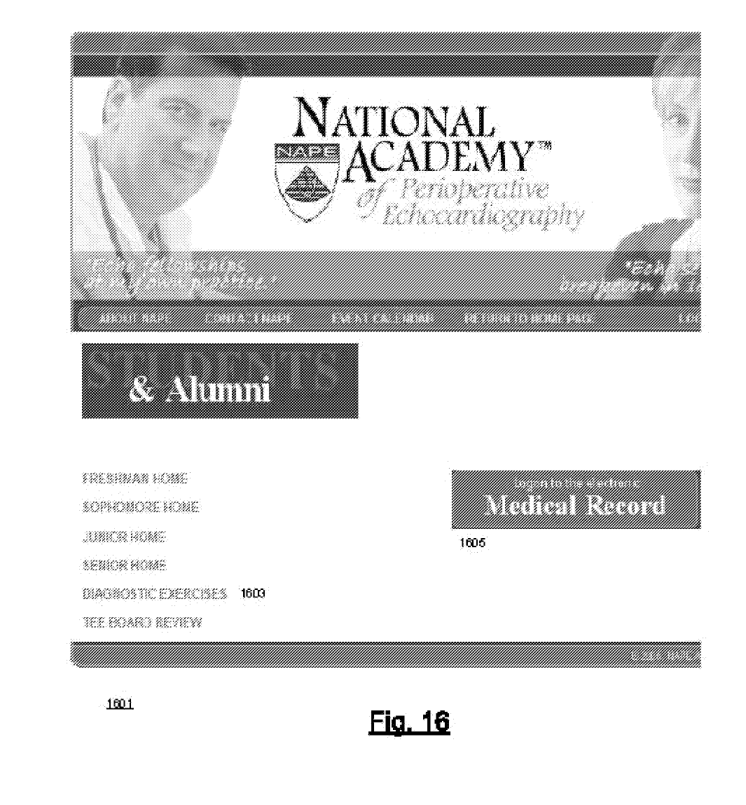

Remote Diagnostic Exercises: FIGS. 16-24

As described in the discussion of the resident part of the curriculum, diagnostic exercises are an important part of the curriculum. One of the requirements of the curriculum is that the student complete 150 diagnostic exercises Some of these will be completed during the resident part of the curriculum, but the student is also expected to complete between 3 and 5 remote diagnostic exercises a week. Each week, the student receives by email a list of studies from his or her instructor for which the student is to prepare reports. The procedure for making a report on a study is the following:

1. Open two (2) web browser windows. In each window, go to the website on server 221 and login 15: (FIG. 16, window 1601).

2. The first browser window will be used to display the echo images for each diagnostic exercise. The second browser window will be used to complete the report (EMIR) for the corresponding diagnostic exercise images displayed in the first browser.

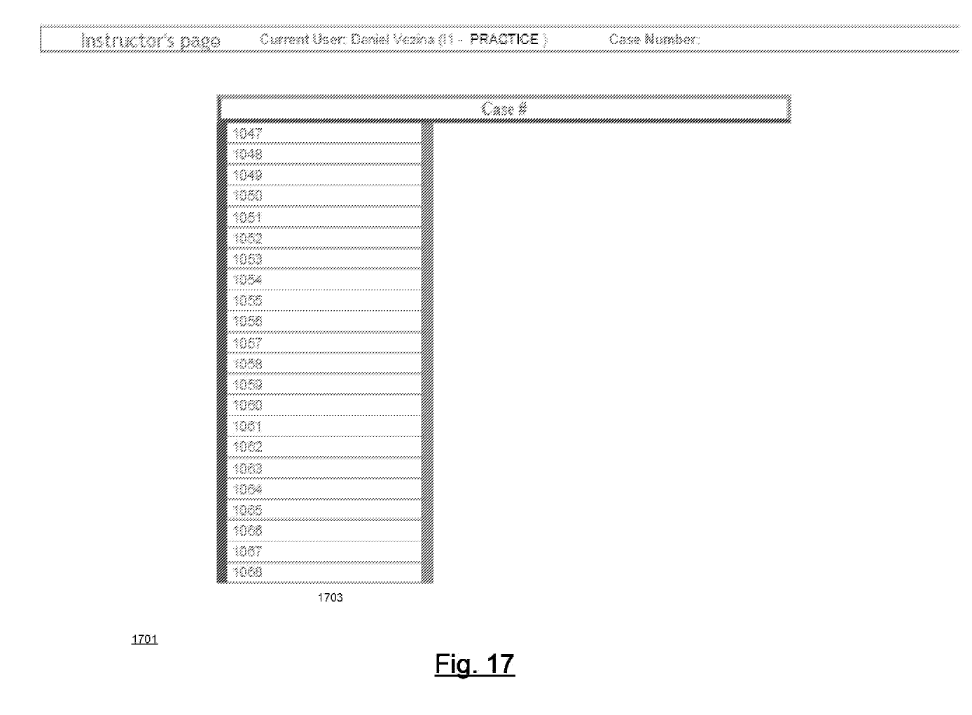

3. In the first browser:
a. Click on the “Diagnostic Exercises” link 1603 on the left bottom of the page. This will bring up a new window (FIG. 17, 1701) with a list 1703 of diagnostic exercises by case number on the left column. There may be more cases than are required for the week's assignment. Each diagnostic exercise will be identified by a case number.

b. Click on one of the case numbers that were assigned for the week. This will display the images associated with that diagnostic exercise in MPEG format. The case number for the diagnostic exercise will be shown in the web address in the email message from the instructor. For instance, if the case number is 1047, the case number will appear in the address line of the web browser as follows:

www.nape-online.com/Diagnostic Exercise/1047/20_{—}01_{—}07_{—}17_{—}02_{—}01/frame_page.htm
c. All the thumbnails (images) associated with the specific diagnostic exercise will appear on the left side of the first browser window.
d. To view a specific image, double click on the image thumbnail. The time it takes for the image to appear and play will depend on the speed of the internet connection.

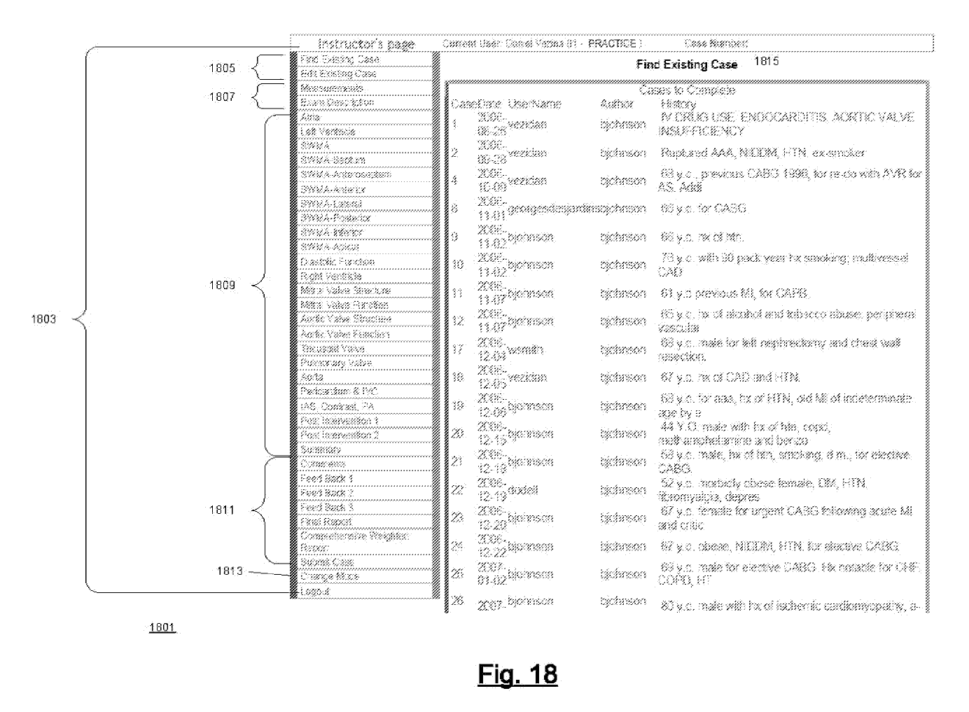

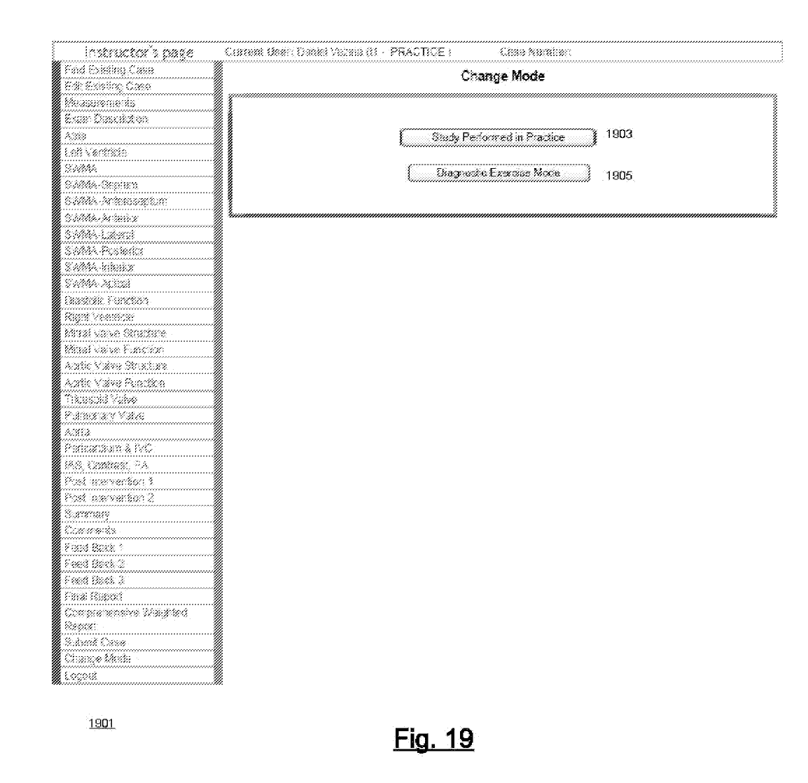

4. In the second browser:
b. In the second browser, click on the large “Logon to the Electronic Medical Record” link 1605.
c. The next page (FIG. 18, 1801) should display the report in “Practice Mode”, as indicated by the header at the top of the page. “Practice Mode” is the default mode. As will be explained later, “Practice mode” is used to write reports on uploaded DICOM studies. The tabs 1803 in screen 2001 appear in all of the windows reached by medical records link 1605. Next, scroll down the menu on the left side of the screen until the “Change Mode” menu item 1813 is reached. Click on “Change Mode” and a page (FIG. 19, 1901) with two selections will appear; “Study Performed in Practice” 1903 and “Diagnostic Exercise Mode” 1905. Click on the selection that says “Diagnostic Exercise Mode”. On mode change, the header at the top of the page will say “Exercise”.

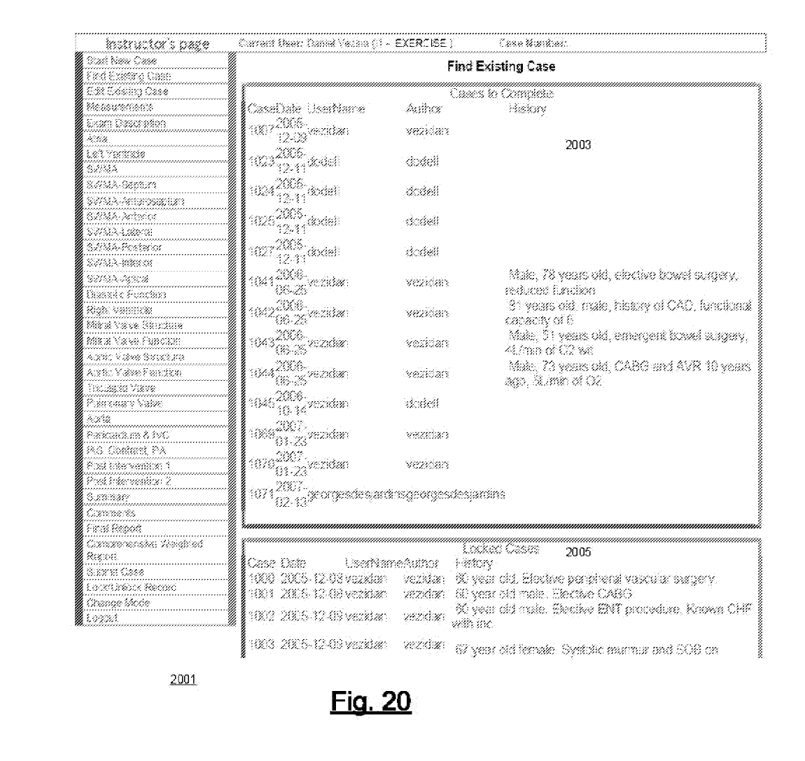

e. In the new window (FIG. 20, 2001), a list of cases 2003 will be displayed in the box on the right. It will be titled “Cases to Complete”. Find the case number that corresponds to the diagnostic exercise case number displayed in the first browser. IT IS IMPORTANT TO MAKE SURE THESE ARE THE SAME CASES. Click on the case number and the clinical case description will appear in the window and the case number will appear at the top of the page.
f. Review the clinical scenario and then click on the “Measurements” tab 1807 of tabs 1803 in the left column to review the measurements associated with the images.

5. Review all the images in the first browser by clicking on each thumbnail one at a time. It is important to review all the images before completing the interpretation of the findings in the report. After reviewing all the images, complete the report in the second browser by making an interpretation of the echo findings. This is done by clicking on the tab in 1809 for each subject area of the report and when the page for the subject area appears, selecting findings from the list of possible findings for the subject area. See FIG. 4.

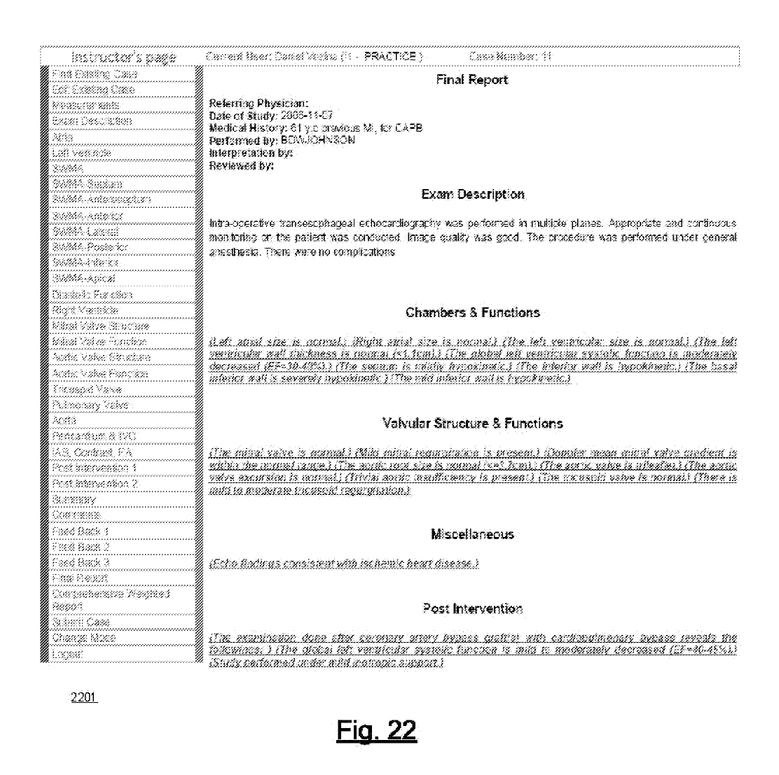

6. When the interpretation and findings are complete, click on “Final Report”, located at 1811 in tabs 1803. This will bring up the final report (FIG. 22, 2201) for review. The findings which the student has selected for his report appear in red.

7. Review the interpretation and findings and when satisfied with the completed report, click on the “Submit Case” tab located at 1811 in tabs 1803. This will bring up a question asking “Are you sure you want to submit the case?” If satisfied, click yes and the report will be submitted for analysis. If you wish to make additional changes, use the “Back” button on your browser menu.

8. Once the report has been submitted, submitted, the server will electronically analyze the report and display the case will be displayed in the lower right box of FIG. 20 under “Locked cases” 2005. Find the row for the case number and click anywhere on the row that it appears. This will load the corrected version of the case. Click on “Final Report” (1811) to review the corrected final report.

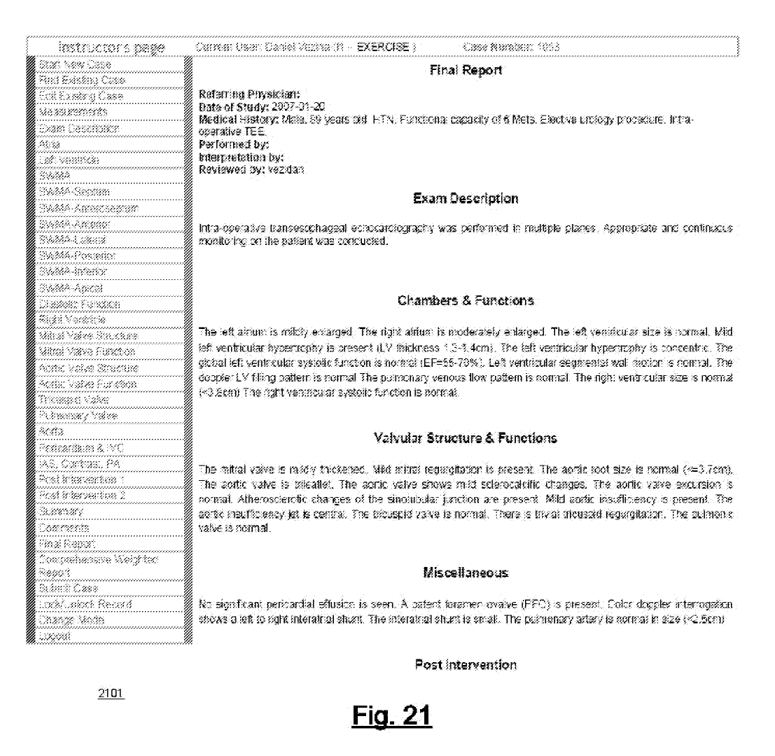

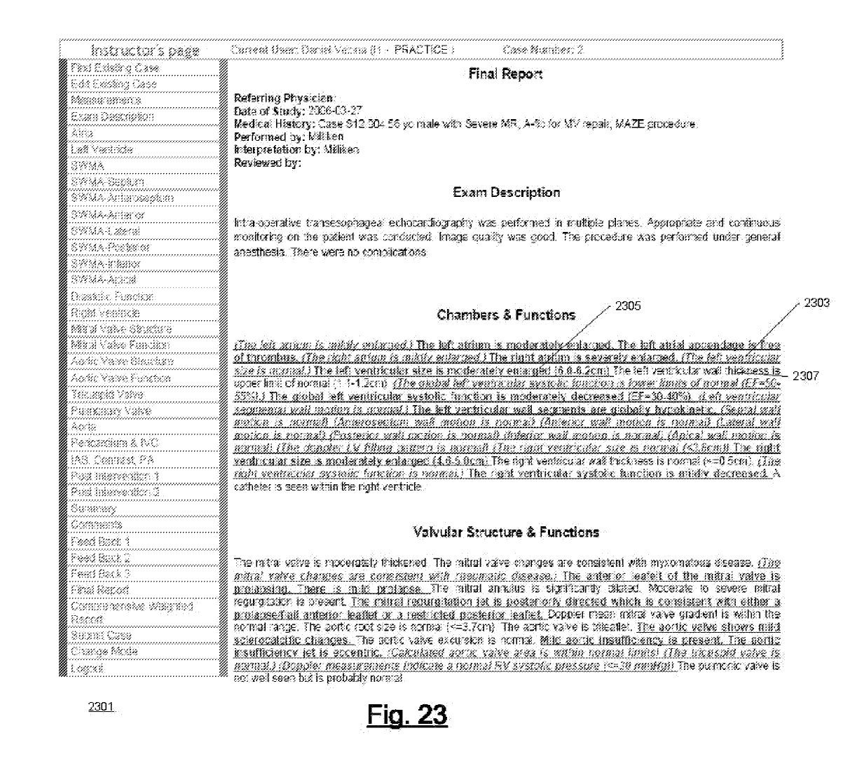

9. The electronic analysis is based on differences between a model report on the case and the report submitted by the student. An example model report is shown in FIG. 21 at 2101. The differences between the submitted report and the model report are shown using different colors in the analyzed report. The sentences in black indicate agreement between the student's report and the model report; The sentences in blue indicate a diagnostic interpretation made by the instructor that differs from the one in the model report or was not commented on by the student. The sentences in red indicate a diagnostic interpretation made by the student that differs from or was not commented in the model report. FIG. 23 shows an example of a use of this technique in a report 2301 based on a study from the student's practice. The text labeled 2303 is in red, the text labeled 2305 is in blue, and the text labeled 2307 is in black.

10. Toward the end of the corrected final report, there are comments/teaching points from the model report These comments/teaching points are included to emphasize the educational components of the case. Please review these points carefully for each case.

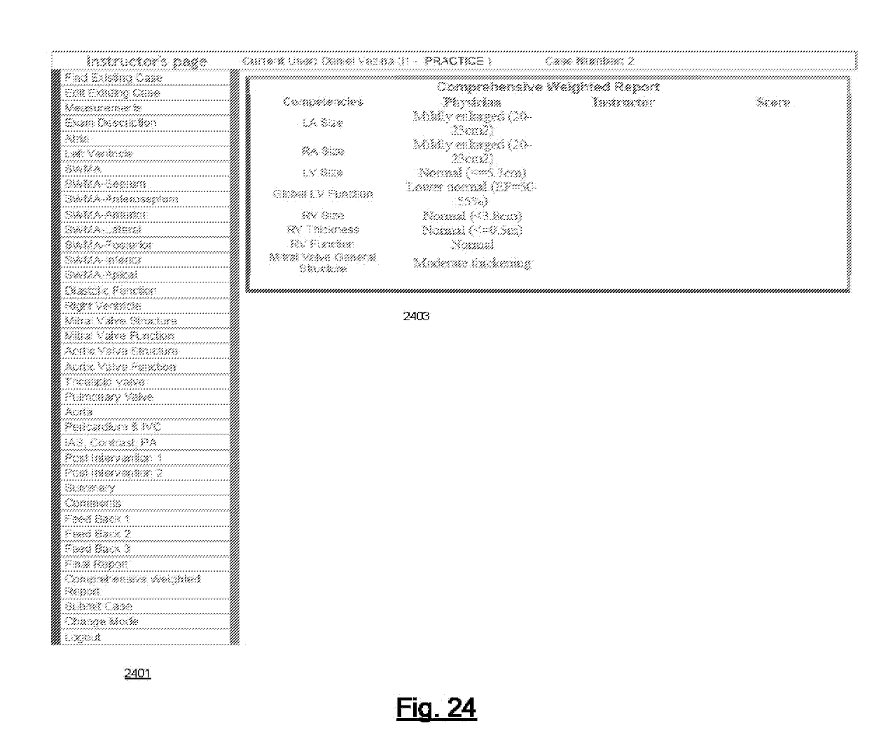

11. Click on “Comprehensive Weighted Report” (1811) toward the bottom of the left column to review the score for the core competencies. The “core competencies” are the aspects of the study indicated by the menu items at 1809. The page 2401 shown in FIG. 24 appears. The portion of the page containing the grade is shown at 2403.

Details of the Implementation of the Remote Diagnostic Studies

The studies used in the diagnostic studies were compiled by the instructors from a large bank of anonymous DICOM echo images that they have accumulated over the years. The number of images selected per cases varies from 20 to 40 clips. The images selected are put together to express one or two teaching concepts or teaching points (for example, aortic valve stenosis with normal filling pressures). Based on experience, there are around 50 important concepts to be mastered by the students and each student needs to review or be tested on each concept 3 times to be able to do it on his or her own after completion of the training program. Therefore, the faculty created 150 diagnostic exercises to be done by the students over a period of one year (about 3 per week). The assigned diagnostic exercises emphasize the concepts being taught in the cycle in which the exercises are assigned. In order to make the images used in the diagnostic studies displayable in standard browser, they have been converted from the DICOM format to JPEG. Each diagnostic exercise takes about 1 hour for the student to complete.

Details of the Electronic Analysis of the Reports on the Diagnostic Exercises

After the student has created his or her report on the diagnostic exercise, the server immediately compares the student report to a previously created “ideal interpretation” stored in the server. The ideal interpretation was made by the instructor who created the diagnostic case. The comparison is done by comparing the entries in case Info table 601 for the diagnostic study's ideal interpretation with the corresponding entries for the student report on the diagnostic study. Where there are differences, the information from the ideal interpretation is appended to the information in the student report. The “final report” tab of the report GUI shows the student the differences between his/her interpretation and the faculty interpretation with different font colors, as explained above.

The scoring shown in FIG. 24 is also done electronically and is based on the ideal interpretation stored in the server. Diagnostic interpretation of the images of a study is mostly a matter of determining the level of severity of abnormalities found in the images. For example, the images of the diagnostic exercise might show a mildly reduced left ventricular contractile function. In making the ideal interpretation of the images, the instructor will choose this possibility from the menu reached by the selection of the “left ventricle” tab in tabs 1809. If the student makes the same choice in his or her report on the images, the score for this diagnosis is 100% (perfect match between student and instructor). If the student selects another possibility from the “left ventricle” menu, there is a difference in diagnosis between the student and the instructor. In grading, the value assigned the difference is determined on the basis of the clinical relevance of the difference (how much of a difference does it really make in real life). Some misdiagnoses will not impact the care of the patient but others may have serious consequences and the value assigned a difference that indicates such a misdiagnosis is high. Continuing with the example, if the student selects the possibility from the menu that states that the left ventricular contractile function was mildly to moderately reduced, the score associated with the difference is 85% (pretty close but not right on and not likely to have serious consequences for the care of the patient). If the student selects severely reduced, the score is 20% because this difference can have serious consequences for the care of the patient. In a preferred embodiment, the weight of a difference in interpretation between the student and the teacher for a particular aspect of the study is determined on a 100 point scale and students' scores are reduced 15 to 20 points (based on the instructor's discretion) for mild differences in interpretation between the student and instructor, 40 points for moderate differences, and 60 points for severe differences.

Grading is done on the basis of grading information in report database 239 which, for each possible pair of diagnostic choices permitted by a menu for a particular aspect of the study, indicates the weight of the difference between the choices. Because the grading information is based on menu choices, it can be used not only to grade diagnostic exercises, but also to grade reports on student studies. It takes a long time to provide the weights for all of the possible pairs of diagnostic choices for all of the aspects of the study, but once this is done, the result is automatic analysis and grading which provides useful feedback to both the student and the instructor. A particularly useful property of the feedback for the instructor is that it provides hard data on the progress of the student. The instructor can quickly identify areas of weakness in a student and deal with them before they result in bad outcomes for an actual patient. The grading system thus prevents “blind leading the blind” situations in which the student repeats the same mistake over and over again and the instructor remains unaware of what is happening.

Once the images, the ideal interpretation for the Diagnostic Exercise, and the grading information have been created and entered in the system, analysis and grading is automatic. Any student can do diagnostic exercises at any time without the help and support of the instructors. The instructors track the core competency scores weekly and can address weak core competency scores either by email or phone call to the student.

Remote Supervision

Non-real-time remote supervision works like remote diagnostic exercises except that the study about which the student is writing the report is one which the student made in his or her practice. The first step is to upload the DICOM file for the study from the student's echo machine 207 to server 221. The connection between the student's echo machine 207 and server 221 is a VPN. The server responds by marking the study as belonging to the student who uploaded it. Then the student uses his or her browser to logs onto the server and clicks the “Logon to the Electronic Medical Record” link in the browser. Because the default mode is that for writing reports on studies from the student's practice, what the student sees is a list of the studies made by the student that the student wishes to have reviewed. The student selects the study he or she wishes to have reviewed. He then displays the study on his own echo machine and uses the browser to select answers from the menus reached via tabs 1809 that correspond to his diagnosis An instructor then views the study that the student uploaded to server 221 on study display 255 and makes his own report on the student's study in the same fashion. The instructor's report on the student's study and the student's own report on the study are then compared and graded as described above with regard to diagnostic exercises for the “ideal report” and the student's report on the diagnostic exercise to produce a commented report on the student's study. Additionally, the instructor adds written comments about the specific study to the commented report. The student can then review the commented report. Report 2301 in FIG. 23 is an example of a commented report on a student's study. To complete the curriculum, a student must submit 150 studies from his or her practice in addition to the 150 required diagnostic exercises.

Real-time remote supervision in a preferred embodiment works as shown in FIG. 9 and described in the discussion of that figure in the parent of the present application and the present application.

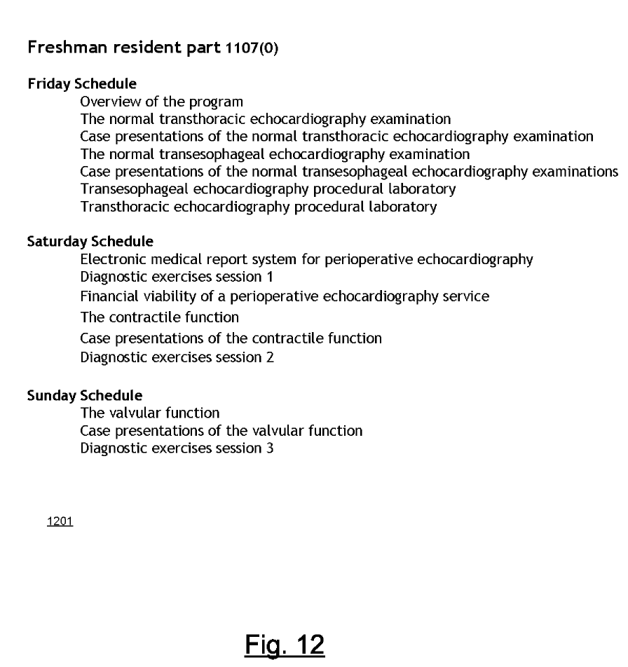

Details of the Echocardiography Curriculum: FIGS. 12-15

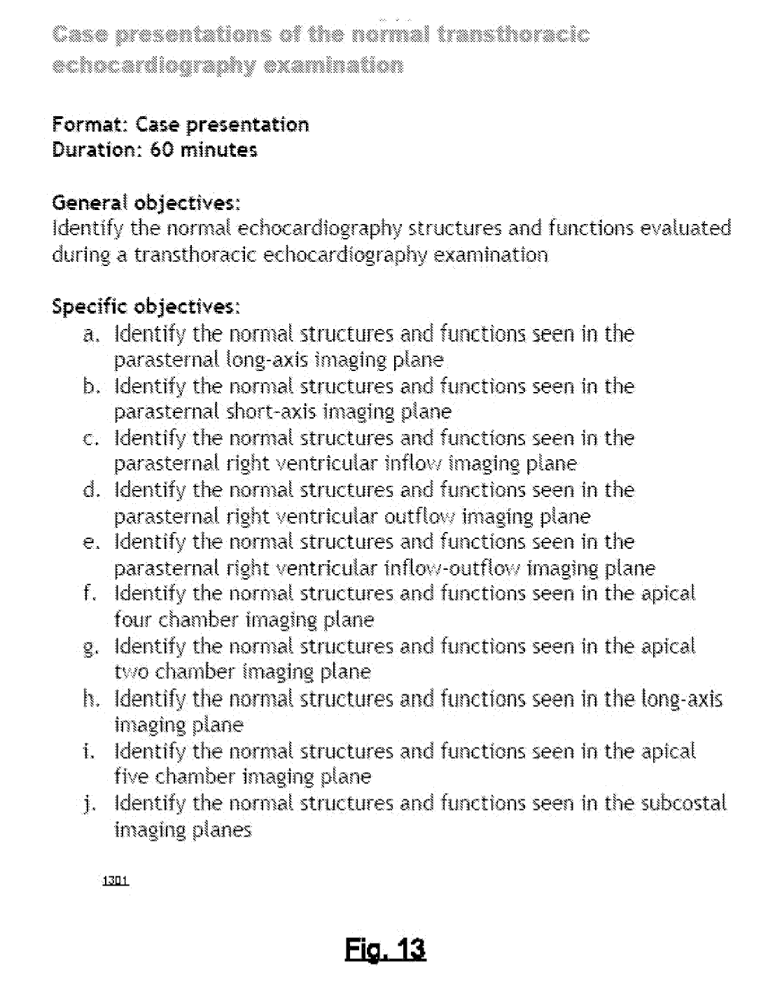

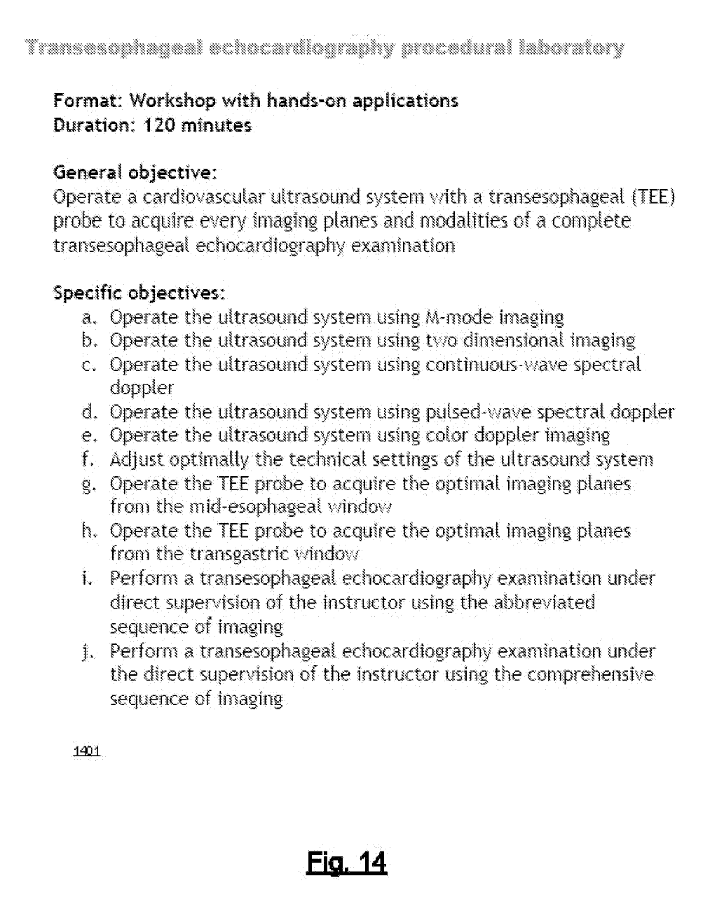

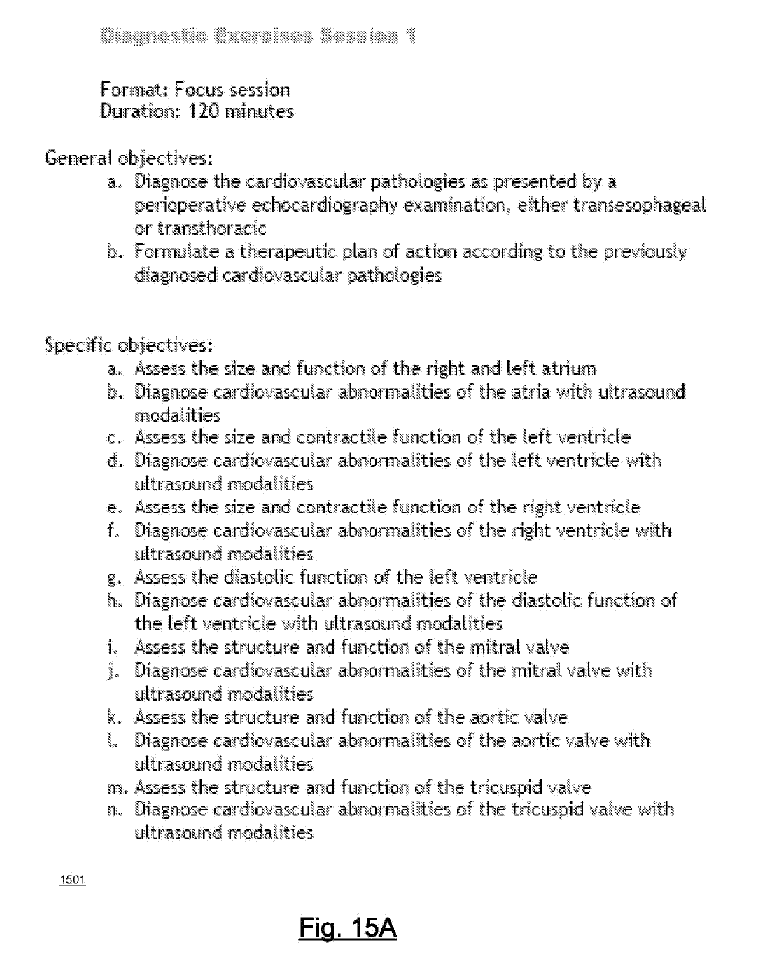

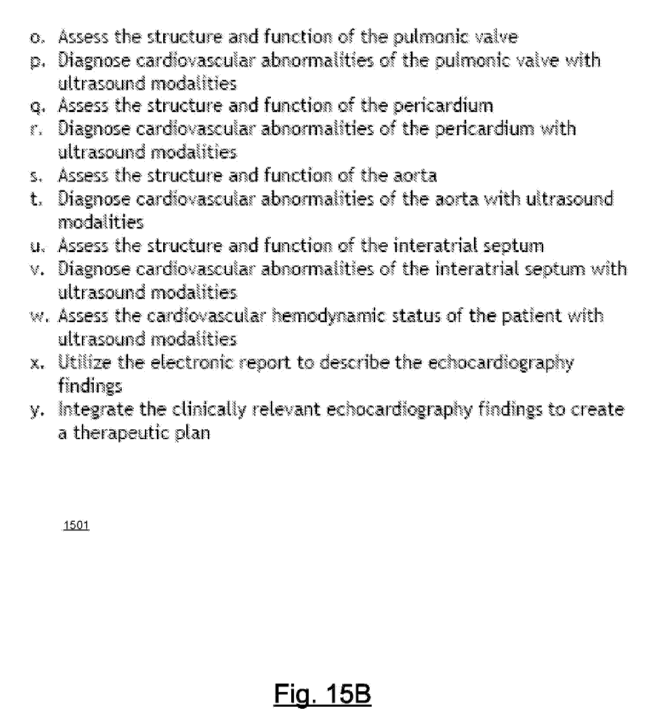

In the following, the detailed schedule for the resident part of freshman cycle 1107(0) will be presented, along with examples of a case presentation, a diagnostic exercise, and a workshop from freshman cycle 1107(0). FIG. 12 shows the detailed schedule for resident part 1107(0) at 1201; as may be seen there, the residential parts take place on weekends, thus minimizing the student's loss of time in his or her practice. FIG. 13 is a detailed outline of a case presentation 1301; FIG. 14 is a detailed outline of a workshop which teaches the student how to operate an ultrasound system using a transesophageal probe and how to do a TEE examination. FIG. 15 is a detailed outline 1501 of a diagnostic exercise; the set of objectives is the same for all diagnostic exercises, be they those done during the resident part or those done during the remote part.

Application of the Techniques to Other Areas of Medicine

There are of course many other areas of medicine which can be taught using the techniques just described for the teaching of electrocardiography. These other areas include but are not limited to
1) Perioperative Echocardiography
2) Cardiac Magnetic Resonance Imaging
3) Non-invasive Peripheral vascular interventions
4) Clinical applications of genomic medicine
5) Cardiac Resynchronization Therapies
6) Clinical applications of plasma based surgical devices
7) Endovascular ablation of arrhythmias
8) Invasive therapies for chronic pain
9) Ultrasound-guided peripheral nerve blockade
10) Minimally invasive and superficial cosmetic procedures
11) Endoscopic applications of gastroenterology

### CONCLUSION

The foregoing Detailed Description has disclosed to those skilled in the relevant technologies how to use the techniques for teaching the use of a test instrument that are disclosed in the Detailed Description and has also disclosed the best mode of practicing the techniques that is presently known to the inventors. It will be immediately apparent to those skilled in the relevant technologies that the principles of the techniques disclosed herein can be used in any situation where what is being taught is the use of a test instrument and/or the interpretation of the output of the test instrument. The manner in which the techniques are applied will of course depend on the situation in which the instruction is being performed, the form of the output provided by the test instrument, the complexity of the output, and the difficulties involved in interpreting the output. The manner in which they are applied will further depend on the networking and hardware environment in which they are implemented. For all of the foregoing reasons, the Detailed Description is to be regarded as being in all respects exemplary and not restrictive, and the breadth of the invention disclosed here in is to be determined not from the Detailed Description, but rather from the claims as interpreted with the full breadth permitted by the patent laws.

1. A method of teaching a student who will be using a test instrument to interpret outputs of the test instrument,
the method repeating a cycle one or more times and the cycle comprising the steps of:
providing resident instruction to the student in interpreting the outputs, the student and an expert in interpreting the outputs being physically present during the resident instruction and the resident instruction being for a resident period of time that is short enough that the resident period of time does not substantially interfere with the student's non-resident activities; and
providing non-resident instruction to the student for a non-resident period of time, the non-resident instruction including
receiving a first interpretation of an output from the student;
analyzing the first interpretation; and
providing results of the analysis to the student.

2. The method set forth in claim 1 wherein:
in the resident instruction in the first cycle, the expert also provides instruction in how to use the test instrument.

3. The method set forth in claim 1 wherein the step of analyzing the first interpretation comprises the step of:
comparing the first interpretation with a second interpretation of the output, the second interpretation being made by the expert.

4. The method set forth in claim 3 wherein:
the first and second interpretations are made by selecting menu items in a GUI, each menu item indicating an item to be included in the interpretation of a particular aspect of the output; and
in the step of comparing, the comparison is based on automatically comparing the menu items selected by the student for particular aspects of the output in the first interpretation and the menu items selected by the expert for the particular aspects in the second interpretation.

5. The method set forth in claim 4 wherein:
the GUI is a GUI in a Web browser.

6. The method set forth in claim 4 wherein:
descriptive material is associated with the menu items; and
the step of providing results includes the step of:
automatically generating a third interpretation which, when the student and the expert have selected different menu items for a particular aspect, includes the descriptive material associated with each of the different menu items.

7. The method set forth in claim 4 wherein:
differences in menu selections are associated with weights indicating the seriousness of the differences; and
the step of providing results includes the step of:
automatically generating a grade which is based on the weights associated with differences between the menu selections made by the student and the menu selections made by the expert for the particular aspect.

8. The method set forth in either claim 1 or claim 2 wherein:
the output is produced by the student; and
the non-resident instruction is provided at least in part using a real-time link between the student and the expert to receive the output and the first interpretation, analyze the first interpretation, and provide results of the analysis.

9. The method set forth in any one of claims 1 through 7 further comprising the step of:
providing the output to the student at the student's non-resident location.

10. The method set forth in claim 9 wherein
the student views the output using a Web browser; and
the method further comprises the step of converting the output into a form suitable for view in the Web browser.

11. The method set forth in any one of claims 1 through 7 further comprising the step of:
receiving the output from the student, the student having made the output at the student's non-resident location.

12. A memory device, the memory device being characterized in that:
the memory device contains code which, when executed by a server, causes the server to perform the step of providing non-resident instruction as set forth in claim 1.

13. A method performed in a system having a processor and memory of automatically analyzing a first interpretation made by a student of one or more aspects of an output from a test device, an interpretation being made using a graphical user interface displayed in the system, the graphical user interface enabling a user to describe an aspect of the output by making menu selections from a menu of items that describe the aspect, and the method comprising the steps of:
making a second interpretation using the graphical user interface of the output, the second interpretation being made by an expert in interpreting the output;
automatically comparing the menu selections made by the student for the first interpretation and the expert for the second interpretation; and
providing results based on the comparison to the student.

14. The method set forth in claim 13 wherein:
the step of providing results include the step of
automatically generating a third interpretation in the processor, the third interpretation including, when the student and the expert have made different menu selections for an aspect of the output, both the item corresponding to the students menu selection and the item corresponding to the expert's menu selection.

15. The method set forth in claim 13 wherein:
the system further includes grading information for the menu selections for the aspect of the output, the grading information associating weights to differences between the menu selections made by the student for the first interpretation and the menu selections made by the expert for the second interpretation; and
the step of providing results included the step of:
automatically generating a grade for the first interpretation in the processor, the grade being based on the weights specified in the grading information for the differences between the menu selections made by the student for the first interpretation and the menu selections made by the expert for the second interpretation.

16. A memory device, the memory device being characterized in that:
the memory device contains code which, when executed by the processor, causes the processor to perform the steps of the method set forth in claim 13.

17. Apparatus whereby instruction in interpreting studies made on an echocardiography machine may be provided to a student by a remotely-located expert, the apparatus comprising:
a server system that is accessible via a network browser to the student and the expert,
the server system including
a first server that provides representations of screens to the network browser and responds to inputs from the browser screens; and
a database accessible to the first server that contains report interface information needed to make first browser screens which are used to make reports describing studies and report information received from the first browser screens for the reports,
the first server
providing one first browser screen to the student which the student uses to make a student's report describing the study and providing another first browser screen to the expert which the expert uses to make an expert's report describing the study,
comparing the report information received for the expert's report with the report information received for the student's report, and
using the comparison to generate a final report which shows where the expert's report information and the student's report information differ and a grade for the student's report which is based on weighted differences between the expert's report information and the student's report information.

18. The apparatus set forth in claim 17 wherein:
the database further contains browser-playable images of studies and display information that is used to make second browser screens that play the images; and
the server provides a second browser screen to the student that plays the images of the study.

19. The apparatus set forth in claim 17 wherein:
the apparatus includes a study viewing system for viewing studies; and
the server system further includes a second server that receives studies,
the second server receiving a study made by the student for which the student has used the student's first browser to produce the student's report and the expert using the study viewing system to view the study made by the student and using the expert's first browser screen to make the expert's report.

20. A method of providing continuing medical education in echocardiography to a student, the continuing medical education in echocardiography including interpreting studies made with an echocardiography machine,
the method repeating a cycle a plurality of times, and the cycle comprising the steps of:
providing resident continuing medical education in echocardiography in which the student and an expert in interpreting studies are both physically present, the resident continuing education being for a resident period of time that is short enough to that the period of time does not substantially interfere with the student's practice; and
providing non-resident continuing medical education in echocardiography for a non-resident period of time, the non-resident continuing medical education including
receiving a first report on a study from the student;
analyzing the first report by comparing the first report with a second report made on the study by the expert; and
providing results of the analysis to the student whereby the student performs supervised interpretations of studies during the non-resident continuing medical education.

21. The method set forth in claim 20 wherein:
the study is a study made by the student.
